(19) United States
(12) Patent Application Publication
(10) Pub. No.: US 2004/0122810 A1
(43) Pub. Date: Jun. 24, 2004

(54) System and method for searching, finding and contacting dates on the Internet in instant messaging networks and/or in other methods that enable immediate finding and creating immediate contact

(76) Inventor: Yaron Mayer, Jerusalem (IL)

Correspondence Address: YARON MAYER, 21 AHAD HA'AM ST, JERUSALEM, 92151, IL

(21) Appl. No.: 10/621,509

(22) Filed: Jul. 18, 2003

Related U.S. Application Data
(63) Continuation-in-part of application No. 10/328,088, filed on Dec. 20, 2002.
Application No. 10/328,088 is a continuation-in-part of application No. PCT/IL01/00572, filed on Jun. 24, 2001.
Application No. 10/328,088 is a continuation-in-part of application No. 10/086,216, filed on Feb. 20, 2002.
(63) Continuation-in-part of application No. 10/086,216, filed on Feb. 20, 2002.
Application No. 10/086,216 is a continuation-in-part of application No. PCT/IL01/00572, filed on Jun. 24, 2001.
(60) Provisional application No. 60/214,003, filed on Jun. 26, 2000.
(60) Provisional application No. 60/359,554, filed on Feb. 19, 2002.
(60) Provisional application No. 60/370,631, filed on Apr. 2, 2002.
(60) Provisional application No. 60/376,235, filed on Apr. 24, 2002.

(30) Foreign Application Priority Data
Jun. 22, 2000 (IL) 136945
Apr. 24, 2002 (IL) 149320
Feb. 18, 2003 (CA) 2,419,120
Jul. 2, 2003 (CA) 2,432,811
Jul. 4, 2003 (CA) 2,432,817

(51) Int. Cl. G06F 17/30

(52) U.S. Cl. 707/3

(57) ABSTRACT

When searching for new people, the current instant messaging networks typically allow users to search mainly by name or by e-mail and some of them also by interests, although one of them (Odigo) allows to search also by sex, age, area, languages, occupation & interests. However, to the best of the inventor's knowledge there is no way to systematically search in these networks for compatible dates by attributes such as for example education, general background, appearance, attitudes, and personality, or by reciprocal compatibility in any of the above mentioned attributes. This is a waste of a huge potential since some of these networks already have more than dozens of millions of people. Also, Odigo allows searching only among people currently connected, which means that highly compatible dates can be missed just because they don't happen to be connected at exactly the time of the search. The present invention is a novel concept which applies computer dating to the context of instant messaging, in a systematic and flexible way that to the best of the inventor's knowledge has never been done before. This system and method enable the user to search and find instantly compatible dates in instant messaging networks on the basis of attribute search or 1-way compatibility search or 2-way compatibility search instead of being limited to search only by the limited options described above, and to search either for potential dates that are currently Online or Offline, and also take advantage of many additional features, and especially features that are based on improved integration between computer dating and instant messaging.

### BACKGROUND OF THE INVENTION

1. Field of the Invention

The present invention relates to instant messaging and computer dating on the Internet, and more specifically to a system and method for computer dating in the context of instant messaging, and/or in other methods that enable immediate finding of potential dates and creating immediate contact.

2. Background

Computer dating means matching people by computer after filling a questionnaire which typically contains a description of a list of attributes in themselves and a list of attributes that they want in their ideal date. Such services have existed on the Internet for a number of years.

Instant messaging is a relatively new technology, in which people are able to find instantly if any individuals in a specified list of friends or acquaintances are logged in to the Internet at a given time and, if so, communicate with them instantly. This technology is typically based on the principle of the client program sending a very short message (with the user's unique id number in the instant messaging network) at relatively short intervals (such as for example once a minute) to a central server or servers whenever the user is logged-in to the Internet and the client program is activated. This way, when these messages cease, the server(s) knows that the user is no longer connected, even if he did not terminate the connection properly. When users know that they are online at the same time, they can start exchanging instant messages or open real time textual online chat. The 3 most known instant messaging networks on the Internet today are ICQ, AOL's Instant Messenger, and Microsoft's MSN Messenger.

However, when searching for new people, the current instant messaging networks typically allow users to search mainly by name or by e-mail and some of them also by interests, although one of them (Odigo) allows to search also by sex, age, area, languages, occupation & interests. However, to the best of my knowledge there is no way to systematically search in these networks for compatible dates by attributes such as for example education, general background, appearance, attitudes, and personality, or by reciprocal compatibility in any of the above mentioned attributes. This is a waste of a huge potential since some of these networks already have more than dozens of millions of people. Also, Odigo allows searching only among people currently connected, which means that highly compatible dates can be missed just because they don't happen to be Online at exactly the time of the search. Also, Odigo does not show people by order of compatibility. Adding such features to instant messaging systems would be a significant improvement over the prior art in instant messaging systems and in computer dating systems.

This ability for instant contact is important also because one of the things that are missing in online computer-dating systems is the ability to have a systematic search for reciprocally compatible dates immediately after filling the questionnaire, and then being able to contact immediately the compatible dates, such as for example by getting their phone number or being able to instantly communicate with them through the Internet. Typically computer dating systems give usually only the e-mail address of compatible dates, or even worse—allow only to leave them a message in a special mailbox within the computer-dating system. This can be very bad because if a normal e-mail is not generated it can take a long and frustrating time to get a response.

The only relevant patent that I saw is U.S. Pat. No. 5,963,951 by Gregg Collins, granted Oct. 5, 1999. However, my opinion is that almost everything in that patent is either trivial or exists already in prior art. And yet he got the patent. The Present invention is much more sophisticated and with much more advance over the prior art. Another relevant patent, which was found in the International Search Report, is U.S. Pat. No. 6,272,467, issued on Aug. 7, 2001, to Durand et. al. However, this patent claims in the background section that “it is believed that most computer dating systems fall into two basic types: (1) linear matching; and (2) one-way compatibility screening. This similar/non-similar type of matching fails to take into account the fact that persons may place different emphasis on a trait in others than on a trait that they themselves exhibit. Moreover, this type of matching fails to account for the fact that males and females place significantly different emphasis on the weighting of factors and also have significantly different tolerances for variability in factors . . . prior computer dating systems thus have failed to employ two-way matching and to utilize a numerical method of evaluating potential matches instead of similar/not-similar approach”. This statement is clearly wrong because for example the present inventor has been running a computer-dating service based on two-way, reciprocal compatibility, which also takes into account the importance for each question, and creates and reports compatibility scores (and also uses for example a minimum compatibility threshold), at least since 1991 in Israel, and since 1995 in the USA, under the name “The Internet Computer Dating Service”, in a web site (http://computer-dating.com) which has been well indexed in major search engines, including for example yahoo, and publicized in the relevant news groups. Therefore, the main “improvements over the prior art” claimed in the above patent are simply not novel and exist in the prior art. Consequently, most of the claims in the above patent can be easily invalidated by prior art. On the other hand I have recently found two patents which might be related partially to some elements in two of the features described below: US application 20020106066 filed on Feb. 5, 2001 by Swanson (published Aug. 8, 2002)(might be related partially to some elements of the feature of “proxy phones”, however it was published after this feature was already included in the present invention and works differently), and PCT application WO 0115480 by Nokia, published Mar. 1, 2001 (might be related partially to some variations of the feature of being able to get an indication if someone is very near to the user in cellular networks).

### SUMMARY OF THE INVENTION

The present invention is a novel concept which applies computer dating to the context of instant messaging, in a systematic and flexible way that to the best of the inventor's knowledge has never been done before. This system and method enable the user to search and find instantly compatible dates in instant messaging networks on the basis of attribute search or 1-way compatibility search or 2-way compatibility search instead of being limited to search only by the limited options described above, and to search either for potential dates that are currently Online or Offline, and also take advantage of many additional features, and especially features that are based on improved integration between computer dating and instant messaging. A further feature of the present invention is that preferably at least in one embodiment it can work also across instant messaging networks, so that users can find each other even if they are members in different instant messaging networks. A further feature of this invention is that it can make the large instant messaging networks also the biggest dating services in the world. It can also help them start charging for payments in the future, after a sufficient number of users have also started using the dating option. It can help them grow even faster for example by increasing further the users' motivation to recommend the system to additional friends. (For example by giving the user more privileges, such as for example additional lists or credit points for each friend that they bring). It might also be extended similarly to cover also chat networks such as for example IRC (for example by coupling an appropriate add-on to the IRC client).

The system and method are preferably based at least on two main elements:

1. A module (or modules) for filling and/or making changes to the computer dating questionnaire, preferably containing self-description, description of the ideal date, and the importance for each question. This module can be implemented preferably as either:

a. An appropriate plug-in or add-on or element in a plug-in or add-on for the client program preferably for each of the main instant messaging networks where plug-ins or add-ons are possible,

b. A standalone application or part of a custom-made instant messaging client.

The data filled by the user is then preferably either saved locally on his/her computer, or sent to a central server (or servers), or both.

2. A search & instant messaging contact module or modules for finding & contacting potential dates (For example by attribute search or reciprocal compatibility search) who are currently Online and/or who can be added to a contactee list (Preferably even if they are not currently Online) in order to notify the user when they are Online again. Preferably, this module can be either based on:

a. A suitable plug-in or add-on coupled to the client program preferably for each of the main instant messaging networks where plug-ins or add-ons are possible, that is preferably activated each time the user activates said client program. Whenever this plug-in or add-on is activated, preferably it first sends the user's compatibility questionnaire data to a central server (or servers) (this is needed for example in case the database of potential dates is dynamic and exists only during the time that these people are logged in, or if the user has just filled the questionnaire for the first time or made changes to it) and then preferably sends only small packets of data containing at least the user's unique id every certain interval. (Taking care of sending these short messages may be done also by a separate element or plug-in or add-on). When the user wants to search for new people to add to his contact list for example according to attributes search or 2-way compatibility search, preferably the search is done either on the dynamic database as explained above or in a static database of users that filled the compatibility questionnaire, according to different embodiments. The system can (preferably in different embodiments, or as options in one program) use either a static database or a dynamic one, or both—for different types of searches and for efficiency considerations. However, even if a dynamic database is used, at least minimal data such as for example the user's name and e-mail and unique ID, is preferably kept also in a central static database on the server. If the search is done on the dynamic database (or on a static database with a request to ignore all those who are not currently Online), the people found are already by definition only people that are currently logged on. If the search is done on a static database of people that filled the questionnaire without the requirement that they be currently online, preferably the user can either:

1. Add them to the contact list on his normal instant messaging client program, and then the user will be notified by the instant messaging client itself whenever they are logged in. However, if some of these persons are members of other instant messaging networks, the user will need to ask them to join also the network in which he/she is enlisted, otherwise he/she will not be able to add them in this way.

2. Add them to a special contact list maintained by the plug-in or add-on itself, and then the user will be notified by the plug-in or add-on whenever they are logged in. This second option is better of course, because it enables the user to be notified also if the target people are members in instant messaging networks other than the one the user belongs to. However, in this case the plug-in or add-on preferably also includes an element that enables the user to communicate and exchange instant messages with users of other instant messaging networks, unless the user asks them to join also his/her own network. Preferably, the plug-in or add-on does this for example by using the same protocol for instant message exchange between plug-ins or add-ons in all types of clients for which we design a plug-in or add-ons. Another possible implementation of this feature is that if the add-on is based at least in part on a wrapper around the client or is more fully integrated with the client, it can for example let the client or part of the client act as if it is communicating with another client of the same network or with its server, but translate the communication to another protocol and/or redirect it, as shown in FIG. 7. This has the advantage of letting the user continue working with the interface and front-end that he/she is used to in his/her favorite IM network. Preferably the system knows if someone is Online either by contacting the appropriate server of the IM network to which the client belongs, or, preferably in a different embodiment, by using our own server and generating our own repeating signal from the client. This is no problem, since in order to participate in the dating, all users of the system on other IM networks are using an appropriate plug-in or add-on anyway, so they all can connect to the same server and use the same protocol for the repeating signal.

Both if the search was only for people currently online or also people offline, preferably the user can similarly add any of the people that came up in the search to his/her list of contactees in any of the ways explained above—so that he/she can be automatically notified when they are Online again the next time (Preferably the user may for example click on them one by one or mark a whole group for adding). Preferably this notification is by at least one of the following ways: When the user is using the client program preferably the program indicates to the user visually and/or by an attention getting sound when a compatible date that is on the contactee list (and/or for example on the list of compatibility search results) becomes online. Another possible variation is that if the user himself/herself is not currently Online, the user can be automatically notified for example by SMS or by email or by preferably automatic phone call when such a date becomes online or for example at least for dates which the user marked as especially important to him/her or requested to be especially notified about them.

b. A complete or independent instant messaging application that works like a normal instant messaging client connecting to a main server or servers, with the added features of being able to search for users for example by attributes or by 1-way or 2-way compatibility. Preferably, the system can also similarly use either a static database or a dynamic one, or preferably both—for different types of searches and for efficiency considerations (preferably in different embodiments), and have features as described above. However, even if a dynamic database is used, at least minimal data such as for example the user's name and e-mail and unique ID, is preferably kept also in a central static database on the server. This complete application can be either a stand-alone, or a plug-in or add-on coupled to a major Internet communication program, such as for example one of the big browsers, or for example an integral part of the browser, so that for example the IM client (or at least part of it) and/or the part of the client that deals with dating are integral parts of the browser.

Definitions and Clarification

Through out the patent whenever variations or various solutions are mentioned, it is also possible to use various combinations of these variations or of elements in them, and when combinations are used, it is also possible to use at least some elements in them separately or in other combinations. These variations can be in different embodiments, or different versions of the software, or sometimes different options available to choose from. In other words: certain features of the invention, which are described in the context of separate embodiments, may also be provided in combination in a single embodiment. Conversely, various features of the invention, which are described in the context of a single embodiment, may also be provided separately or in any suitable sub-combination.

As used throughout the entire specifications and the claims, the following words have the indicated meanings:

“Client” or “Client program” is an application that runs on the user's computer and communicates with a server or servers, usually on the Internet. In the context of this invention, Client means Instant Messaging Client, unless stated otherwise.

“Server” or “Servers” as used throughout the patent, including the claims, are always meant interchangeably to be either server or servers. “Server” is a computer on a network that is running software (or the software itself) that provides data and services to clients over the network (which can be any kind of network, including the Internet).

“Our client” or “Our own client” refers to a custom-made instant-messaging client with the features of this invention built-in.

“Our server” or “Our own server” refers to a custom-made instant-messaging server with the features of this invention built-in.

“Standalone” is an application that runs on it's own.

“Plug-in” is an application that runs as part of or as an addition to another application and is called from it when needed. “Add-on” is a more general term than plug-in and refers to elements or features that are added to or coupled to a given application in any way possible, such as for example a plug-in or with a program that wraps around it, or in any other way allowed by the application or by the operating system. As used throughout the text of the patent, including the claims, these terms are meant to be interchangeably either plug-in or add-on.

“Plug-in” or “Plug-ins” as used throughout the patent, including the claims, are always meant interchangeably to be either Plug-in or Plug-ins

“Add-on” or “Add-ons” as used throughout the patent, including the claims, are always meant interchangeably to be either add-on or add-ons.

“User” or “users” as used throughout the patent, including the claims, can interchangeably to be either user or users, and can refer to both sexes even when words such as “he” or “she” or “his” or “her” are used.

“Dynamic Database” as used throughout the text, including the claims, means that the data from the users questionnaires is kept on the server or servers only as long as they are Online, so when a user becomes Online again his/her data is resent from his/her client program to the server.

“Static Database” as used throughout the text, including the claims, means that the data from the users questionnaires is kept on the server or servers also when they are not Online, and preferably their Online/Offline status is kept as part of their records or in a separate file or pointer or index. Of course ‘static’ does not mean that the data in the database doesn't change—data can be updated as often as needed.

“Database” or “Databases” or “DB” as used throughout the patent, including the claims, are always meant interchangeably to be either database or databases.

“Contactee list” or “Contact list” or “Buddy list” refers to the list of people for which the user wishes to be notified when they are Online.

“History list” in instant messaging systems is the list of previous messages exchanged between the user and a given contactee.

“IM” is short for Instant Messaging.

“Cellular phone” or “mobile phone” or “wireless phone” as used throughout the patent, including the claims, can mean any device for communications through wireless and/or cellular technology, including for example Internet-enabled cellular phones, such as for example the Japanese DoCoMo, 3^{rd} Generation cellular communication devices, palm computers communicating by cellular and/or wireless technology, etc.

“Computer” as used throughout the text of the patent, including the claims, can refer to a personal computer, or any automated device or gadget with one or more processor or CPU, capable of more than simple arithmetic functions. This includes for example also cellular phones and portable computing devices such as for example palm pilot.

“Online” or “logged-on” or “logged-in” as used throughout the text of the patent, including the claims, in the context of IM networks means that a user is connected to the Internet, with the IM client open, unless for example the contact has been open for a long time and the user hasn't typed anything (or clicked or responded or shown any other type of activity). In the context of Online Computer Dating Services it means that the user has logged into the system for example with his/her user name and password not longer than a certain time ago (for example within the last 20 minutes or any other reasonable time frame), and/or the user has performed at least one activity in the system (such as for example view data, change data, or perform a search for compatible dates) not longer than a certain short time ago.

“Internet” is the Internet as it is now, or any other similar network that exists or will exist in the future.

“Self Description” or “Self data” throughout the text, including the claims, means the answers the user gives about himself/herself in the Dating Questionnaire. Except for some special questions, the user can preferably choose just one answer in each question for his/her self-description. For example, the user marks that he has dark hair in the question about hair color.

“Desired date”, “Ideal date”, “Preferences” or “Wanted” throughout the text, including the claims, means the answers the user gives about the optimal and acceptable levels he/she wants to have in the desired date in each question. Preferably, the user can choose more than one option in the “wanted”, and preferably also specify the level of desirability of each option that he/she prefers. For example in hair color the user may want Blonde girls with higher desirability and red hair with lower desirability.

“Importance” or “Weight” means the level of importance the user gives each question, for example: Doesn't matter, Slightly important, Important, Very important, Extremely important, or Necessary.

“2-way compatibility” means that the matching is done by taking into account both the user's self description and preferences and each potential date's self description and preferences, and preferably also the importance given by each of them to each of the questions.

“1-way compatibility” means that the matching is done at least by taking into account the user's preferences and each potential date's self description and preferably also the importance the user gave to each question. However, preferably even when conducting 1-way search, the system actually does a 2-way search, in order to check that the user also fulfills the potential date's expectations by at least a certain minimum, preferably defined by the system. Since the dating questionnaire is preferably long, containing for example above 100 questions, preferably when conducting 1-way or 2-way searches the data is used directly from the saved questionnaire.

“Attribute search” means that the user just marks a certain preferably small number of attributes that he/she wants to search for in the potential dates. The importances for this small set of preferences can be for example assumed to be necessary, or in another possible embodiment the user can specify the importances even in this case. Preferably this fast search is either conducted by ignoring the user's self description, or conducted similarly to the 1-way search described above, except that the attributes are preferably defined by the user on the fly and used instead of his/her full list of preferences. Preferably, the results of the attribute search can be for example just dates that fulfill a 100% of the requests, or any percent above the defined minimum like in the 1-way and 2-way searches.

“Frozen” means that a certain user does not receive compatible dates lists and does not appear on other users' lists until the user requests to be unfrozen or the system decides that a certain event has occurred that justifies unfreezing him/her (for example if the user has reentered the system after being Offline for a long time and the freezing was done automatically by the system due to lack of activity and not due to a specific request by the user).

### BRIEF DESCRIPTION OF THE DRAWINGS

FIG. 1a shows a preferable structure of the client-server system in the instant messaging network, with the part that implements the dating.

FIG. 1 is a schematic diagram of a preferable way the questionnaire-filling application works as a plug-in or add-on within an instant-messaging client.

FIG. 2 is a schematic diagram of a preferable way the questionnaire-filling application works as a standalone application or as part of a custom-made instant messaging client.

FIG. 3 is a schematic diagram of a preferable way that a dynamic database of users that are currently Online works.

FIG. 4 is a schematic diagram of a preferable way that a static database of users that filled the compatibility questionnaire works.

FIG. 5 is a schematic diagram of a preferable way the search plug-in or add-on conducts attribute and compatibility searches within the context of the instant messaging client.

FIG. 6 is a schematic diagram of a preferable way attribute and compatibility searches are conducted within a custom-made instant messaging client.

FIG. 7 is a schematic diagram of a preferable way that the add-on can for example let the client or part of the client act as if it is communicating with another client of the same network or with its server, but translate the communication to another protocol and/or redirect it to the other network.

FIG. 8 is an example of a preferable way that the extended contactee list can look like.

FIG. 9 is an example of a preferable way that the list of most compatible dates following a reciprocal compatibility search can look like.

### DETAILED DESCRIPTION OF THE PREFERRED EMBODIMENTS

All of descriptions in this and other sections are intended to be illustrative examples and not limiting. The system and method described may be also regarded as a virtual machine that performs the described functions.

FIG. 1a shows a preferable structure of the client-server system in the IM network, with the part that implements the dating. The instant messaging client (2) runs within the user's computer (1), and, if it's not a custom-made client, is preferably coupled to a plug-in or plug-ins or add-on or add-ons (3) for adding the special features of the present invention, otherwise the parts that implement these features in the client are part of the client itself. The user's computer (1) is connected through connection (4) to the Internet (5), where our server(s) (6) (with dynamic or static database(s) or both (7)) reside. The database (no matter if dynamic or static) is of course preferably run by the server, and all date searches are preferably carried out there, although there can be for example a separation between the server (or servers) that handles the IM activity, and another server (or servers) that run the actual dating database and perform the searches and compatibility matches, etc., and return the results to the requesting client programs.

Preferably the system also has at least one or more of the following improvements over existing Instant Messaging systems:

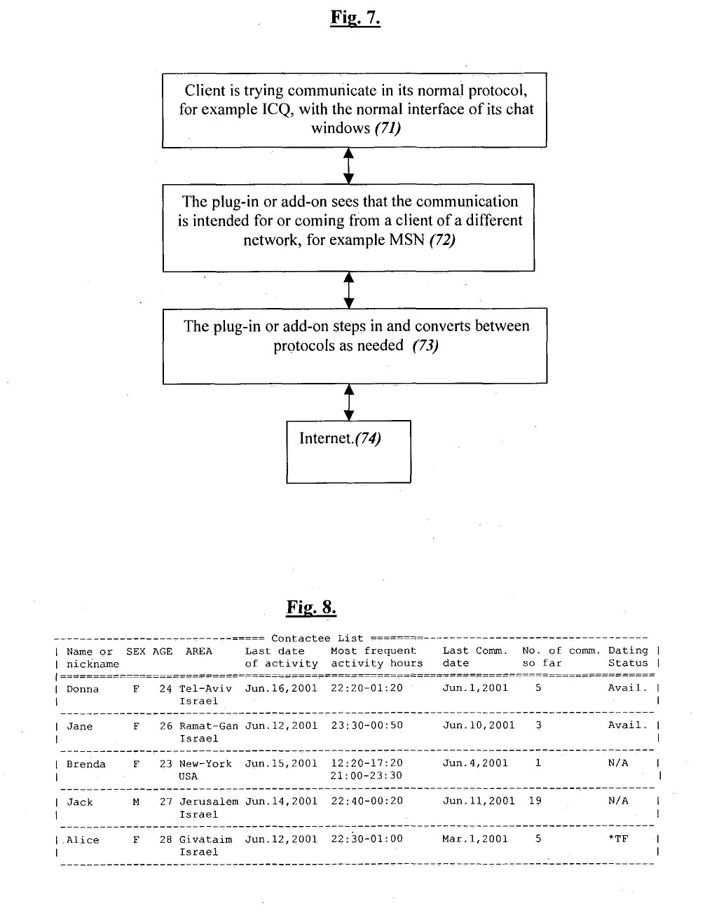

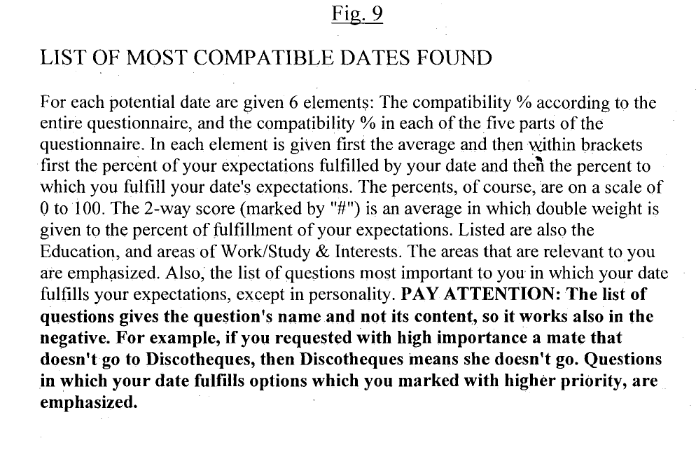

1. The contactee list is preferably run by the client program (2) in the customary shape of a table, but preferably indicates also near each contactee additional data such as for example the last date & time he/she was online (in the instant messaging network) and/or the most common range of hours and/or week days he/she is most likely to be found online (In another variation this can be a more crude time range, such as for example, morning, noon, afternoon, early evening, late evening, and night), and/or for example the last time he/she performed a search for potential dates in the system (preferably the client program automatically gets these updates from the server when the user is Online), and/or geographical area (or for example some relative distance estimate compared to the user), and/or the compatibility scores, and/or how often they are usually online (such as for example how many hours on average per week or per day). This is very important since many times, and especially if the user has not used the system for some time, it is very hard to tell which of your contactees are still available and when it is likely to encounter them. Preferably near each contactee is listed also the last time contact was made with him/her and/or for example the length of his/her history list. Preferably, the table of contactees contains also a visible status indication about each person—for example if he/she is still looking for romance or other types of connection, etc. Preferably these additional data fields are visible by default near each contactee without having to click on anything in order to see them. An example of a way the contactee list can look like is shown in FIG. 8. Of course, like other features of this invention, these features can be used also independently of any other features of this invention, so that for example at least some of these additional data (such as for example the last date & time the contactee was online, the most common range of hours and/or week days he/she is most likely to be found online, and/or how often he is usually online) can be used also in contactee lists of IM networks that are not integrated with dating. Of course it is also possible for example to keep a separate contactee list only for contactees that were added through the dating, instead of keeping them for example in a separate sub-list as shown in the example of FIG. 8, but that is less preferable.

2. Preferably the user can choose if to sort the contactee list according to alphabetic order, compatibility score (at least for those contactees that were added through the date-searching), or any of the other data mentioned in clause 1 above, or additional data, or any combinations of these.

3. Preferably the user has the ability to know how many people have him/her in their contactee lists and/or for example how many people received him/her in their dating lists. This is very easy to accomplish since either the user's client program or the server or both can for example increase a counter or decrease it whenever someone adds or deletes the user. Another possible variation is that the client program or the server or both can also keep a list of all the people that added the user to their contactee lists, so that the user can for example send messages that can be automatically distributed to all of them, and/or request to view the list of people that have him/her on their lists (preferably at least their names and e-mails and/or IM ids). So preferably the server and/or the client program keep for each user also a “reverse” contactee-list, which lists all the other users who added him/her to their list and haven't deleted him/her yet. Another possible variation is that the server keeps only a copy of each contactee list and when needed the server runs over these lists and searches them, preferably with the aid of an index. (Of course, if the act of adding someone to the list of contactees is reciprocal, then the client program can know automatically that you were also added to their list, but this is not necessarily so, especially in cases that the person has not limited adding him to the list to requesting explicit authorization. Also, even if the adding to the contactee list could in some systems be automatically reciprocal, there is no reason why the deletion should be like this: if person A deletes person B from his list, it does not necessarily mean that person B wants to delete person A from his list, so the deletion process would make it non-trivial to know on which or on how many contactee lists you are actually listed).

4. Preferably, if someone changes his/her status for example from “available for dating” to non-available, etc., this is automatically broadcast (for example by the client program of that user or by the server) to all the people who have him/her on their contactee list, so that his/her status is updated on their lists (This can be done for example by an automatic message directly from that user's client program that updates the client programs of these people when they are Online and if they are Offline preferably waits for them till they are Online again, or for example done similarly through the server). This updating is of course preferably in addition to making the person not appear in further date searches by others if the change in status implied this (until the status allows this again)—for example if he/she is in a relationship, etc. Another possible variation is that preferably each user can also remove himself/herself automatically from all the contactee lists where he/she is listed and/or at least for example block certain users for example by being deleted from their contactee lists or by making the system never let them know that the user is online. However, these, like other features, can preferably be used only with a password and/or other safety means so that no other users can make such changes in the user's name by pretending to be the user.

5. Preferably when the matching potential dates are found, they are listed by descending reciprocal compatibility score. However, since there can be a large variance between the way people mark the acceptable ranges in the “Wanted” in each question and the way they mark the importances of questions, the score of how much someone fits the user's expectations can depend very much on the general bias of the user, in other words his/her tendency to be more or less “generous” in general in his/her scores. Therefore, in order to create a certain minimum normalization, preferably for sorting by reciprocal score, the score of how much the potential date fits the user's expectations is preferably given stronger weight (and thus effects more the reciprocal score, which is a weighted average) than how much the user fits the potential date's expectations. Another possible variation is to create some normalization of this by taking into account for example the average 1-way score that the user gives compatible dates and his standard deviation, and thus either use normalized scores, or use the normalization to create only a partial correction of the absolute scores. This is more preferable than full normalization because the fact that someone gives generally higher scores to everyone can also mean that he/she is really more open and more fit for many people than someone who gives lower scores in general. This can have the effect of automatically also reducing the number of times such a person appears on other users' lists, in order to improve the balance. If such normalization is used, preferably the relevant data, such as for example average score and standard deviation is saved in the date's record, preferably following his/her own searches, so that it is immediately available without further calculation the next time that date is matched with someone. Another possible variation is for example to automatically limit at least temporarily the number of times the user can appear on other users' lists if his/her number of appearances in other lists has gone beyond a certain excess limit defined by the program (preferably in terms of percentages, since the absolute numbers change as the database grows). Preferably such a limitation can be for example defined automatically by the system and/or for example specified by users who request such limitation. Another possible variation is to allow the user to specify more than 2 levels of acceptability, for example 3 levels (For example: optimal, desirable and acceptable). This can increase the flexibility and allow a better approximation to the real curve. In addition to this, preferably if a user's compatibility scores are generally low beyond a certain criterion, preferably the system can report to the user (for example automatically or upon the user's request after displaying this option) the list of questions that most contributed to the problem (for example the 10 questions that most lower his scores with other people, or all the questions that contributed more than a certain factor to lowering the scores, preferably in descending order of magnitude of effect and/or for example in descending order of the importance of these questions to the user). This can be done for example by letting the matching program that runs on the server keep statistics for each user while running him/her against the potential dates, so that the statistics track the questions that are most problematic. Another possible variation is to run this statistical check only upon request and/or only on a subset sample of potential dates in order not to slow down the normal matching process when running the search on all potential dates. Another possible variation is to allow any user, even if there is no problem, to request and view for example a similar list of all the questions that had most effect on lowering or on adding to the compatibility scores, preferably in descending of magnitude and/or importance. Another possible variation is for example to give the user also the option of choosing sorting by 1-way compatibility scores, and in that case preferably the user will get someone only if the opposite 1-way compatibility score is above a certain minimum, preferably a minimum set by the system and not by the user. (In other words you can request a sorting by how much the mate fits your expectations, but you will only be allowed to get mates whose expectations you also fit to a certain minimum). Preferably in this case the search results list shows also the reverse compatibility for each date. Of course these options can be used also in normal computer-dating systems. As mentioned above, preferably the user has also the option to request just a search by a list of traits, which is in other words a 1-way compatibility but typically on a small number of traits and without necessarily checking the opposite 1-way score, but in this case preferably the system can for example create various limitations such as for example that persons who don't fill the questionnaire completely (or at least a minimal subset of required questions) cannot participate at all in searches by others, etc., or for example not giving the person's phone, etc., in order to reduce the chance for harassment if the search ignores the reverse compatibility. So if the questionnaire has for example about 150 questions, preferably the users can have a very systematic and serious compatibility search, but also experiment with instant searches especially when first trying out the system, by filling just the Wanted and the Importance in the few questions that most interest him/her, and thus start getting results already from the first minutes. So for example within minutes after entering the system for the first time, the user can search for example for all the blondes with high IQ and a big bust that are either currently online or not. Allowing such huge flexibility is very important because each persons can want very different things so a very large number of questions to choose from is preferably given to the user, eventhough the user might choose for example just 3-10 questions to start with, but these are the few questions most important to him/her. (When choosing this option after the user has already filled the full questionnaire, preferably these requested traits are used instead of his preferences as marked for the full questionnaire, and his self data from the questionnaire can preferably either be taken into consideration or not, or taken into consideration at least partially, depending on the type of search or other considerations). Another possible variation is to allow any two users of the system to check the exact compatibility between them, for example by entering their two unique Id numbers and thus get normal compatibility scores or for example an even more detailed analysis (Of course the detailed analysis can preferably be requested by one or both of the users, however the level of analysis can preferably reveal more if it is requested by both users). Such more detailed analysis might include for example the lists of questions that most contributed to or reduced their compatibility scores (preferably in descending order of magnitude of affect and preferably with an indication of the points or percents added or deleted from the score by each such question), and/or for example a numeric and/or verbal and/or graphic display of the level of matching on each question (if a graphic display is used then preferably for example the color and/or size and/or shape of the marks can show the level of matching on each question and/or the importance of that), listed for example in the original order of the questionnaire, or for example sorted in descending order of importance or for example in descending order of matching, so that the most highly matching question are listed at the top. The above lists can be either separate, for example one list or group of lists for showing the 1-way matching to the first person and a 2^{nd} list or group of lists for showing the opposite 1-way match, or the lists might be combined, so that for example the questions are listed only once and for example only the reciprocal match is shown for each question, or also the 2 1-way matches. Another possible variation is to include in this analysis for example also the serial position of each of the two persons on the other person's list, in other words, how many other persons with higher compatibility exists (for example there are 125 other potential dates with higher compatibility than the 2^{nd} person for the 1^{st} person, i.e. he/she would appear on the 1^{st} person's list at the 126^{th} place, and there are for example 80 other potential dates with higher compatibility than the 1^{st} person for the 2^{nd} person). Of course, various combinations of the above variations are also possible.

6. Preferably, if the user requested a search also on people who are not currently Online, those that are Online appear in the list of results with a preferably easily visible mark, such as for example a different color indication and/or text size and/or shape and/or special icon, or for example two or more separate lists are generated (or one list divided into two or more parts), one with people currently online and one or more with people not currently online. Within each list or part of the list preferably the results are still ordered by descending compatibility score. Preferably near each person in the list of people not currently online there is also additional data such as for example when they were last online and/or how often they are usually online (such as for example how many hours on average per week or per day), and/or for example on which hours and/or days they are usually online, as shown in the example in FIG. 9. Another possible variation is that the list of people who are not currently online can be further divided for example into smaller parts, so that for example people who were online in the last week appear in a section before people who haven't been online for example for more than a month, etc. Within each section preferably the sorting is again based on descending, preferably reciprocal, compatibility score. Preferably the size of each section can be determined automatically for example both by the compatibility score and by the recency. Another possible variation is that when dealing with people not currently Online the system automatically tries to come up with a list of most compatible dates (preferably in descending order of compatibility) who are most recent (for example people who joined or were active within the last 3 months), and if the scores are not high enough and/or the list is not long enough (preferably according to criteria determined by the system), the system automatically decides to create instead a list containing also people who are less recent—for example people who were active within the last half year, and so on in one or more steps, until the list is long enough and/or the scores are high enough and/or the recency compromise has reached some time limit of going backwards enough (which can be specified for example by the system and/or by the user, for example people who were active with the last 15 months). If this variation is used then preferably it is done very efficiently for example by automatically keeping during the search conducted for the user a table of most highly matching scores for each of the above time steps (for example a table of the for example 150 highest scores for people who joined or were active for example within the last 3 months, a table of the for example 150 highest scores for people who joined or were active for example within the last 6 months, a table of the for example 150 highest scores for people who joined or were active for example within the last 12 months, etc.), and then the system can choose for example the table of the shortest period which contains sufficiently high scores, and simply display to the user on that run only dates who joined or were active within that time frame (Of course, the above time steps and the table size of 150 highest scores are just examples and other numbers and time steps can also be used). Another possible variation is that there are no separate sections according to recency, but the compatibility score itself and/or the sorting takes into account to a certain degree also the recency, for example according to a weight assigned for the recency factor, determined either by the user or by the system or both. Preferably the mark that indicates if someone is currently online (and/or for example also the availability status of each date, but that is less important since availability for dating typically changes much less often than being Online or not, so it will be updated anyway when the user performs a new search) can be automatically updated also on the list of compatible dates, if the user for example saves the list or keeps the window of the list open, like in the automatic updating of the contactee list, as explained in the reference to FIG. 8. This way the results list can for example assume also additional functions of the contactee list, thus becoming in a way a special contactee list for dating results. Of course various combinations of these and other variations are also possible. Of course many of the variations mentioned here and in other clauses can also be used in normal computer-dating systems. An example of the way the results can look like is shown in FIG. 9.

7. Preferably the client program can receive automatic updates from the server, so that for example if questions (or options within questions) were added or deleted or changed in the compatibility questionnaire, it will be updated when the user is online with the client program. This is important, since unlike normal dating services on the Internet, where the questionnaire is typically on the server, in this case, for efficiency the questionnaire can be in the client itself, which also enables filling or correcting the questionnaire also when you are offline. Another possible variation is that the client program retrieves again a new updated copy of the questionnaire when the user goes online. Preferably the client program can also be itself updated automatically when needed, for example by sending automatically new modules to all the users in the IM network. This feature if it had existed in advance could for example be used to add the dating option to all the ICQ users in the world almost instantly (or for example to add additional features to it later), without waiting for them to go and download a new version of the client program. This is very important, since even if users are informed about a great set of new features, it typically takes a long time till they go and actually download it, and the lag in updating causes incompatibilities between users who have already downloaded the new version and users that didn't. It can be also much more efficient in terms of bandwidth. (However, for reasons of security, when this automatic update occurs, preferably the user is informed about it by the system and asked for confirmation).

8. Preferably, If the user is accessing the system from a client program on a different computer then preferably after giving an Id and password, the client program can get his/her questionnaire data and a copy of his/her contactee list from the server, so he/she can still work normally in the instant messaging network. However, this means that a copy of each user's contactee list is preferably kept also on the server.

9. Many of these concepts can also be similarly implemented also in cellular phone networks, and especially in networks where the phones are constantly connected and there is high bandwidth, such as for example in the 3G (3^{rd} Generation) cellular networks. In such networks, in addition to the normal ability to send the person an e-mail or an instant message, preferably the user can also generate for example an SMS message, or generate a phone-call right from the instant-messaging client. However, (both with cellular and non-cellular phones) in case some people don't like to give their phone in the questionnaire for example for fear of harassment, preferably the system applies an optional “phone proxy” or “phone escrow service”, which means that the user has an option to mark his/her phone as protected, and when someone gets his/her phone on the list, that someone can call the user for example through a special visible code but the code does not contain the real number and the call has to go through the proxy. The call itself can be done for example by direct activation though the client program (if it is done for example from a cellular phone connected to the Internet, or from a computer with a microphone and sound card), or for example through phoning a special number and then clicking the code, and the server there automatically routes the call to the real number. The call routing can then of course be through the normal phone system, but is preferably done as much as possible by using VoIP (Voice Over IP) preferably through the Internet at least part of the way, so that either it becomes a local phone-call, or for example the call is eventually routed to an invitation to enter Voice mode if the called user is online and has a sound card with a microphone. This way various protections can be implemented, such as for example allowing only a few first calls through the code and if the caller does not get from the user his/her real phone number by then, he/she can no longer use the code, thus automatically preventing harassments. The code can also be for example uniquely generated for each person who conducted the search, so that the code cannot be used by someone else. Also, since the code can preferably be changed very easily, the user can preferably also request to change it immediately if harassed by someone, so that someone can't use it anymore even if the use limit hasn't been reached yet. Preferably this can also be used for example to enforce normal calling times and/or preferred calling times specified by the user, so the system preferably uses the information about the country from the questionnaire and/or the time data from the system on each user's computer or cellular phone, and using an updated table of time zones, preferably when someone is calling through the code, the system makes sure that the call will not be for example in the night hours of the person being called. Another possible variation is that even without a code, simply clicking for example on a phoning option near the displayed date can immediately connect the user to that person without disclosing at this stage the number itself. This has the further advantage that this clicking option is available only to the user, so there is no code that can be transferred to others. Of course, such a “Phone proxy” system can be used also in other Online computer dating services that want to allow the user to get a list of dates which can all be reached immediately by phone, so those that don't want to give the phone can use the “protected phone” option. Although US application 20020106066 filed on Feb. 5, 2001 by Swanson (published Aug. 8, 2002) describes an anonymous telephone communications system, this is different because the Swansom method checks compatibility after the request for voice communication is initiated, which is less efficient. In addition, preferably direct Voice communication over IP is available whenever two clients are in chat mode using the IM chat features if they have a sound card with a microphone. Of course, various combinations of the above variations are also possible.

10. Another problem in such constantly connected cellular networks, and also for example in other constant Internet connections, such as for example through cable TV companies or through ADSL, a new definition is needed about what it means to be “online”, otherwise everyone on those networks can be defined as being online all the time (especially if the Instant messaging client is configured to connect automatically when starting an Internet connection). Therefore, at least in such networks preferably the user is considered to be online for example only if he has initiated or responded to any action related to the Instant messaging client for example in the last hour (or any other reasonable time) and/or is considered to be off-line for example if he hasn't typed anything on the computer for a certain time, etc. This means of course that preferably the static and/or dynamic database is updated also according to these activity rules and not only when a user activates or deactivates the client or the connection. Another possible variation is to use these or similar rules also in any type of connection, as explained also in the definition of “Online” in the definition section.

11. In cellular networks preferably the system contains also additional features, such as for example being able to get a special indication if someone is very near to the user, for example within a certain radius. This can be accomplished for example by using info from the cellular company's cells, and/or by using this info directly from the phones, for example when they become GPS enabled. This way the user can know for example that some compatible date is very close to him/her (for example by a special mark in his list of search results and/or in his contactee list). Another possible variation is for example that if the user sees someone that he/she likes and both have cellular phones and are members of the system, then preferably a certain optical or wireless signal generated by the phones themselves can tell the user through the status if the person next to him/her is available, and preferably the two phones can exchange Id's or numbers automatically and/or the questionnaire data directly and thus the client program can immediately run a check (preferably through the server) to see how compatible the two persons are. Preferably this is done by a short range wireless technology, such as for example Bluetooth, since Bluetooth technology will probably be standard on most cellular phones within the next few years, but it can also be any other short range wireless technology that is used or will be used in the future, such as for example UWB (a pulse-based technology, without a carrier-wave), which can easily compete with Bluetooth. Another possible variation is that the client program on each or at least on one of the phones or cellular devices can run the matching between the user and the potential dates in the immediate area without the need to access the server for this, for example by running a local, preferably limited, version of the matching program and preferably limiting the check to the one or more relevant persons around. Therefore, this feature can be used also independently of the IM network and/or of the online dating service, for example by simply letting cellular phones that are close to each other and are marked by their user with the status “available for dating”—exchange data and/or check automatically compatibility and alert the user anytime he/she is close to someone available for dating and compatible. A more limited implementation of this that does not even need a real matching program is for example to use this method just to let the user know that someone next to him/her is available for dating, or use it for example with a minimum amount of data, such as for example age, sex, education, etc. If the match is sufficient, then preferably for example the user or each of the matching persons gets at least a few minimal details about the other person's appearance (such as for example Appearance, Height, Body build, Hair length, Hair color, Hair shape, etc., and/or a picture, if available, or “approximate image” if available, as explained below in clause 16, if no real picture is available) in order to be able to try and match this with what he/she sees around, and the other person's phone number (or “proxy number”, as explained above, and/or an option to click for example on a phone icon near the date's data and be connected immediately), and/or be able to enter for example immediate textual chat with the other person. This can be useful for example at a university, on a bus, on a train, in shopping malls, etc. Another possible variation is that the phone (or other mobile device) can use for example the GPS of its own position and the position of the potential date and use for example its own north-west or compass direction, in order to point to the user the direction and distance to the potential date that was found, or for example use also geographical information such as for example a street map (obtainable for example from the nearby cells), in order to let the user know more exactly the location of the potential date. Another possible variation is that the cellular phones (or for example palm or other relevant cellular or wireless devices, as explained in the definitions) are able to exchange various queries between them. For example each user can mark that out of the large number of questions to choose from there are for example 5 questions which he/she would like to know in advance: for example, apart from is the other person available for dating, what is his/her level of education, what is his/her main area of work or study, etc. Preferably the user can also send the query with additional specifications in order to increase the chance that the reply will come from the right person. For example in a bus or train or university cafeteria or library there can be dozens or even hundreds of people within range. So if for example it is a blonde girl that looks a certain age, preferably the user can ask for example that only the devices of blonde girls that are available for dating and within a certain age limits reply. The query is then preferably transmitted by the bluetooth (or other short range communication) to all the devices in the vicinity that are in range, and each device checks if its user is marked available for dating, and then if he/she fits the definitions, before broadcasting the reply to the question described above (such as for example is the person available, what is his/her education, what is his/her field of study or work, etc.). Preferably there is a different answer if the person is not available than if he/she is not a member of the system, otherwise a lack of reply could mean ambiguously both of these possibilities. Another possible variation is that the phone (or a preferably small and non-conspicuous add-on coupled to the phone) enables the user to point his/her device directly at the direction of the person that caught his/her eye, which preferably transmits some Id code and/or the phone number of the user who points it, and preferably sensors on that device of the person that was pointed to can find out that someone pointed the device and reply to the query directly with its own Id and/or phone number, etc. This pointing device can be based for example on infrared or on a directional short range wireless antenna. (This can work also on other devices even without the cellular network, such as for example palm devices that are bluetooth enabled even if they are not connected to the cellular network, or special gadgets for dating). However this is less desirable, since at least some people might be embarrassed to buy a special device for that and/or embarrassed to be seen pointing the phone at someone. Another possible variation is to implement it for example on the level of cells or groups of cells, so that the cellular phones know that they are close to each other for example by getting the information from the cellular company's cells. Another possible variation is to run the matching normally, but when dates are found that according to the info from the cells and/or for example from the GPS and/or for example from the bluetooth indication (or other short range communication technology) are also very close to the user, these dates are preferably for example marked with a special conspicuous sign (for example in the search results list and/or or in the contactee list) and/or moved to a special category on top of the list of date search results and/or in the contactee list, or their score for match on area is increased by a certain factor and simply incorporated in the total compatibility score. In this version, preferably dates that are close for example by blutooth indication are given even a more emphasized mark and/or moved higher to the top than dates who are only close by info from the cells. Since for some users the level of compatibility is much more important as long as the date is still within a reasonable area, while for others the fact that someone is now very close to them might be more important, preferably the user can easily experiment with increasing and reducing the weight given to the immediate vicinity factor. Also, for example people looking for pen-pals will probably put much less weight on the area. Another possible variation is that the system allows the user also to request separate search results lists (and/or contactee lists) according to area or marking for closer people—also more generally, such as for example putting all the people from the same country or state or town in a separate category. Another possible variation is that if the server or servers become for example too overloaded because of too many users using the system, preferably different servers are used for different areas and date searches are for example limited in the size of areas that can be requested. Although the above mentioned WO0115480 application by Nokia describes the idea of alerting users when a nearby match in cellular networks is around, this clause 11 describes also many new and different variations. Also the Nokia patent did not refer to instant messaging. Of course, various combinations of the above variations are also possible.

12. Preferably if someone hasn't entered the system for a certain time period, such as for example a few months (and/or if someone else fills a for example a “freeze form” or some other form of report about that person, reporting that the person said that it is no longer relevant), the server can preferably generate an automatic message to him/her (for example through e-mail or instant message) to ask for example if he/she is still interested in compatible dates, and if the person confirms this, or if no reply comes back for example after a certain period and/or preferably after sending more reminders, the person is preferably automatically “frozen” (so that people no longer receive him/her in the searches) until there is another indication (for example if he/she enters the system, or performs a new search, or updates the data, etc.). Preferably, the freeze form contains also the reason (such as for example the person found someone through the service, found someone elsewhere, found someone through the service and got married, found someone not through the service and got married, etc.). Another possible variation is that the system ignores the “freeze form” (that was filled by someone else) if the user has been active very recently or is currently Online, and especially if he/she performed a dating-related activity such as for example conducting a date-search recently. Another possible variation is that the system does not ignore the freeze form if the reason is more significant, such as for example the person got married according to the report. By using this feature the weight given to the recency data can be significantly reduced since this can significantly decrease the chance that the potential dates found will be no longer relevant, even if their data is older. (of course if the user fills a freeze form about himself/herself, then there is no problem).

13. In one of the possible embodiments, preferably when the matching is done, the matching program (which is preferably on the server or servers), can take into account at least in some questions (preferably except in questions where the user marked the question as “necessary”) also the distance between what was requested and what was found. For example, if the user wanted a date that is only “Highly above average” in appearance and an otherwise highly compatible date rated herself as just “above average” in appearance”, the number of points taken down because of this mismatch can be lower than if the date rated herself as “average”. This is preferably implemented especially for example in ordinal scale questions which are also subjective in nature, since in such questions the replies both in self description and in the requested ideal date should preferably be taken with caution. Preferably, this distance function can in some cases take into account also the direction of difference, and regard the distance differently depending on this direction. For example, if the user wants someone who only has a post secondary education and the date has a B.A., the “damage” to the user should be much smaller than if the user only has high school education. A more extreme variation of this that the system automatically complements the wanted scale upwards at least in some of these cases where it clearly makes no sense to ask for something bad and not mark also better options, however this is preferably done with caution since my own research has shown that in many cases users still insist on the “unreasonable reply” even when confronted with it. However this more extreme variation is not needed when the users fill the questionnaire online, since the filling program itself can warn them about such illogic request, and if they still insist then so be it. Another possible variation is that when taking the distance into account the system preferably takes into account also the distance from the optimal level (or levels), so that for example if the user marked that he/she wants a date with appearance average or above but marked for example higher preference for “average” than for “above average” and for “much above average”, then the “damage” caused by a date who is below average is less than for example if the user marked a lower preference for “average” then for the higher options.

14. When matching by area, some computer dating systems today match by letting the user mark his/her own area (for example town, state and country), and also a list of areas from which the potential dates can be, and some match instead for example by zip code. However, using the zip code alone is problematic because zip codes depend on many things and do not necessarily translate to actual distances. For example in Australia a small difference in zip numbers can represent a huge distance, compared for example to Honk Kong where it can represent much smaller distances. A better solution is to use matching by selected areas, and use other info such as for example the absolute difference from subtracting two zip numbers only as a supplement. So preferably the difference in zip codes is used only when the date is in one of the requested areas. Another possible variation is to take the zip code into account when the date is outside the requested area, in a way similar to the distance function described in clause 13 above. Anyway, this can work only within countries since the zip system can be different between countries. Another possible variation is to use for example the first few digits of the phone numbers (or the absolute difference (subtraction) between the numbers) instead or in addition to zip data. However this is problematic since it does not help for example if people give a cellular phone instead of their stationary phone number. Preferably this is used in addition to the variation of using proximity data described in clause 11. Another possible variation is to use directly absolute Geographical location information, such as for example GPS coordinates, for example directly from each user's IP address, since this Geographical Location will be probably available in the next generation Internet. This is much more reliable and exact than zip code. Another possible variation is to still use this together with the areas selected by the users. Of course various combinations of the above variations are also possible.

15. Preferably the user can also request from the system to notify him/her automatically whenever there is a new potential date that entered the system and has a higher compatibility with him/her than at least one criterion (such as for example higher than the lowest compatibility score in his/her current contactee list, or higher than an absolute minimal score defined by the user), or fulfills a certain condition, for example, all blondes with big bust and high IQ. Another possible variation is that this is done for example automatically by default unless the user requests otherwise. This is better than the state of the art, where the user gets a list only at certain times (such as for example once a month or, when he/she himself initiates a search). This can be applied for example when the new person submits his/her data for the first time to the system or performs a compatibility search for the first time, and preferably the user can ask either to be notified for example whenever such a new person exists in the static database, (if there is a static database), or only when that user is also Online (Of course when submitting the questionnaire or performing the search the new person is by definition Online, but the user that wished to be notified might be for example offline at that time and when he/she comes back Online the new person might be offline already). This can be done for example by keeping pending search requests (preferably only one search-request or up to a few pending search requests permitted per person) and/or keeping the minimum criterion for that person on his/her record on the server (for example the lowest score on the list that he/she got so far and/or the lowest score on his contactee list so far), and for example when the new person sends his/her data for the first time or requests a search or changes the data (but for efficiency reasons most preferably this is done only or mainly when the new user requests a search), a reciprocal search is performed on all the potential mates in the system, and while checking the new person's data against each relevant potential mate in the system, the server preferably also checks if a condition has been fulfilled that requires sending the appropriate notification or update to the person against which the new person's data is being checked. This may sound a bit inefficient but preferably it has only a relatively small effect on the search speed, since various optimizations can be performed anyway such as for example stopping the comparison with a given person immediately for example if the area doesn't fit or the age doesn't fit. Preferably the user can also choose for example if he/she wants to be notified by an e-mail and/or instant message and/or by automatically having the new persons be inserted into his/her list of contactees (This choice can be made for example in general, or depending on the case, so that for example the user requests that someone be added automatically into his/her contactee list only in cases of especially high matching). Preferably the new person also has the choice in advance if he/she wants to be inserted automatically into the contactee lists of relevant people or at least for example into the contactee lists of the persons that appear in high places his/her list of date-search results and/or fit one or more other criteria or conditions. This saves a lot of time and increases the chance for instant connection, especially if the new person prefers for example that the other dates contact him/her (females for example tend more than males to prefer to wait for someone to contact them). When the user is a member through cellular phone and not currently Online, another possible variation is to notify the user also for example preferably by sending an automatic ring signal to the phone and then displaying the message, or for example sounding a voice message, or for example by SMS. Preferably by clicking on an icon or option near the user's data the user can than automatically enter for example chat mode with the person or initiate an automatic call to the person (Preferably without knowing the actual number at this stage—at least if the new person requested the “Proxy-phone” method, or with the actual number). This can be used also for example whenever someone highly compatible enters within Bluetooth range from him/her or is close according to the information from the cells, or for example from the GPS, and then preferably the user is also given data that can help him/her locate the person for example by showing the appearance data that are available, and/or giving the user more precise location data, such as for example pointing him/her to the direction and distance of the potential date, and/or giving for example street information, as explained above in clause 11 (However, this is intended mainly for locating someone on the street, and preferably not for giving the exact address where he/she lives, so that the actual address from the potential date's questionnaire is preferably not given to the user even if available. Also, preferably users can request to block this feature so that potential dates that get their data will not be given pointers to their exact location). Another possible variation is that for example instead of sending the notification preferably as soon as possible after the new date becomes available, the system waits for example until one or more such highly compatible dates become available and if they do (for example 2 or 3 or 10 such dates are now available) then the message is preferably sent immediately, otherwise the system preferably waits a certain time limit, for example until one hour or for example up to a few hours or for example up to a few days, and if no additional highly compatible dates that meet the criteria become available, then the message is preferably sent anyway (The maximum time till the notification is sent and/or the minimum number of highly compatibles dates that forces sending even before the time limit has been reached can preferably be defined for example by the user and/or automatically by the system). However this is less preferable since the idea of instant dating is best served by instant notification for each new such date without waiting for an additional time or additional dates. As explained in the patent summary, another possible variation is to use a similar notification for letting the user know when a compatible date that is already on his contactee list and/or on his compatibility search results list becomes online: When the user is using the client program preferably the program indicates to the user visually and/or by an attention getting sound when a compatible date that is on the contactee list (and/or for example on the list of compatibility search results) becomes online. Another possible variation is to use for example a more attention-getting notification at least for dates that the user marked as especially important to him/her or requested to be especially notified about them. Another possible variation is that if the user himself/herself is not currently Online, the user can be automatically notified for example by SMS or by email or by phone call when such a date becomes online or for example at least for dates which the user marked as especially important to him/her or requested to be especially notified about them. Of course, various combinations of the above variations are also possible.

16. Since practice shows that most people in computer dating services, including Online services, don't like to send their pictures (Typically for example only less than 10% or even just 5% send their own photo) but prefer to search dates that have pictures, preferably the system allows users to use a systematic data pool of pictures (which can be for example a taxonomy or hierarchy), preferably with real photographs (for example hundreds of pictures of male faces, hundreds of pictures of female faces, and similar separate sets for body shapes) and to choose at least one face that is most similar to the way they look and preferably also at least one body shape that is most similar to the way they look (preferably the marking is on a scale, so that the user indicates also how much he is similar to that picture or image), and preferably also mark similarly the kinds of appearances they would most like in their ideal date (for example by marking the pictures that they most like, preferably with the ability to indicate the level of liking on a scale). Preferably there are more faces to choose from than body shapes, since there is much more possible variation in faces. Another possible variation is to use preferably-carefully drawn images, which makes it easier to control more systematically various variables (or for example some photos and some drawings, etc.). Another possible variation is to make the choices (for example both for self description and for description of the ideal date) more modular than just body and faces, thus allowing the users to create more combinations. This is also important because it is very difficult to properly cover appearance, which is holistic, by a few analytic questions. So by using this method we overcome both the problem that only few users are willing to submit their photographs and the problem that it is hard to sufficiently cover appearance by analytical questions. Preferably when this additional info is available it is used for the scoring of compatibility in appearance in addition to the normal textual questions about appearance. Preferably when there is no direct match between marked self image (of the other person) and marked preferences in these images (a direct match is for example if the user marked that he wants females who look like any of systematic female photos numbers 520, 700, 819, etc. and the potential female date marked herself as similar to one of these photos, and preferably the matching takes into account also the scale of how similar that female marked herself to the photo and/or how much the user marked that likes the photo, in order to further refine the matching score on this), the system takes into account a also the distance or similarity between the preferred and the actual image, preferably based on the systematic classification of the images according to various variables. Preferably this analysis is done on the distance between the images that were marked by the user as preferred images and the image or images that were marked by the date as most similar to himself/herself (and of course preferably the relevant parameters of each image are coded in advance as numeric data so that no actual image analysis is done during the compatibility search). Of course, if reciprocal compatibility is used then preferably the test for direct match on marked images (and also such analysis of distance or similarity if it is used), is done both ways, once based on the user's preferences and once based on the date's preferences. On the other hand the variation of checking only if there is a direct match or not, without analyzing the distance if there is no direct match, can be much more efficient. If such an analysis is used and if the date submitted also an actual photo then another possible variation is to run such an analysis of distance or similarity in addition or instead also with the actual photo, however this option might be much less efficient and might also be less reliable unless the system is able to automatically analyze the actual photos supplied by the users at a high level. Similarly, another possible variation is to check the similarity to an actual photo supplied by the person, if is it available, for checking if there is a direct match, however that might be again much less efficient, since, in contrast, checking if there is a match between images from the systematic pool marked by the users is preferably based on just checking if there is an overlap in a small list of picture serial numbers. However, the efficiency of dealing with actual photos submitted by the users can be considerably improved if they are analyzed in advance and coded according to various parameters so that during the actual matching run only these codes are used, as explained below. So for example when an actual photo supplied by the user is available the actual photo can be used to correct when needed the marking by the user of how similar he/she is to the pictures of the systematic pool (or even instead of the marking by the user), and then in the actual matching run preferably only the corrected marking is used. But, as explained above, this might be in fact less reliable than using the marks made by the users unless the automatic analysis is very sophisticated, since automatic intelligent analysis of photos can be very problematic. When a potential date's data is displayed, and when no real picture of the date is available, preferably this “approximate image” is displayed instead. This has the additional advantage of saving bandwidth and saving space and load on the server, because for approximate images it is sufficient to transfer just some numerical codes. Preferably these pictures or images are small and are downloaded automatically as part of the client, so that viewing them does not overload the server. (Preferably they can also be automatically updated sometimes by the server when needed, like the other updates described above in clause 7). For efficiency reasons, preferably when letting the user mark choices many images are displayed on the screen together, as long as they don't become too small to discern the important details. Another possible variation is that the user is preferably asked to make choices in a tree-like manner—for example choose first between a number of images and then refine the choices based on the previous choices (For example the user can be shown at first for example 12 images which are typical of various main branches in the taxonomy, and after he chooses one or more preferred branches he is shown at the next step for example 9 images that are typical each of a main sub-branches of the chosen one or more branches, etc. However this is just one example and many other variations of this are also possible). When the choice is made for self description preferably the user can choose only one answer on each step in the tree (However, as explained above another possible variation is that even in this case the user can mark at least in some stages more than one option, for example if he thinks that he is sufficiently similar to more than one image), and when the choices are made for the desired date preferably the user can mark multiple options at least in some of the stages. (Preferably at least the top of the decision making tree may contain textual descriptions and/or explanations instead or in addition to images). Another possible variation is that preferably the user first fills the textual questions about appearance and then the system displays the graphic choices already based on the textual information about the self description and about the desired date. This narrows down the choices that have to be made and the number of images that actually need to be displayed and thus increases the efficiency. This way even if thousands of images are available to choose from, the choices can still be made very quickly and very efficiently. Another possible variation is that this is used even with users that do send a photo, in addition to the photo, because of the above described advantages in comparison to just using photos. Another possible variation is, instead or in addition, to use similar methods with the actual photos that are supplied by users, so that for example if the user browses through photos of opposite sex users, he/she can for example request to view for example more photos (or all photos) that are similar to a certain photo (or more than one photo) that he likes and then the system automatically shows him those photos, for example sorted by descending order of similarity to that photo (or photos), and/or to use this as one of the criteria for the automatic matching. However that can be more difficult to implement since it might require almost AI analysis of the photos to determine how similar each two photographs are. Since there can be a number of possible parameters or dimensions on which the similarity is based, the system can assume for example that the most similar pictures are those which have a highest total similarity score across the various dimensions or parameters, or for example the system can search among the available photos for a list of similar photos based on one or more different parameters each time, and then decide according to the user's following responses which dimensions are actually more important for him. For example the system can find by trial and error that after finding for the user a list of female pictures that are most similar (according to various parameters) to a certain one or more previously marked pictures, the user actually likes mostly the pictures with the same hair style and the same hair color, and for example does not really care about many other parameters. Another possible variation is to create an automatic analysis of these parameters by looking for the common features among the pictures which the user initially marks as most desired. (With the systematic pool of pictures the automatic analysis of similarity between pictures is not needed since each user indicates the pictures to which he or she is most similar, however, as explained above, another possible variation is that for users that included an actual photograph of themselves such automatic analysis is also used in addition to or instead of the user's own rating, in order to further improve the reliability of this subjective ranking, if such an automatic analysis is itself sufficiently reliable). Another possible variation is that the systematic pool prepared in advance is used mainly for the automatic scoring of compatibility, and the request for photos similar to a actual user's photo is used more for browsing, for example if the automatic scoring of similarity between two photographs is not reliable enough. On the other hand, preferably similar browsing of actual user photos can also be requested for example for photos that are similar to any of the systematic photos that the user marked as desirable, and in this case the system can use for example the users' own ranking of similarity, so that for example the system lets the user browse all (or some of) the photos of females which marked themselves as similar to the desired photos that the user marked, preferably in a descending order of similarity according to how similar the female marked that she is to that photo. In any of the above variations where the actual photos supplied by users are also taken into account, preferably the photo is automatically analyzed in advance after the user submits it according to various parameters in order to convert it into numerical codes, so that during the actual compatibility search and/or during searching for similar photos preferably only these numerical codes are used. (Another possible variation is to make such analysis for example by principles of holography, so that for example each photo is coded in advance according the results of its holographic processing, but, again, this can be very problematic if for example various light or shade effects change the way that someone looks, so intelligent analysis is preferably for this). Of course, various combinations of the above variations are also possible. Another possible variation is to use these approximate images (and/or real photos when available) to create Virtual Reality environments where users can “meet”.

17. Another problem, that exists both in IM networks and in Online dating service, is that many times the same user enters the system under more than one identity, for example because he/she forgot his/her login and/or password, or because he/she wants to get again a free bonus that is offered only to new users, or because he/she wants to experiment with a few different identities, or other reasons. However, this can create a number of problems, such as for example making it hard to know how many real people are actually in the system, the possibility that a user will get someone on the list or lists of compatible dates more than once, with different compatibility scores each time, and making it hard to determine if a user is really new or not in systems where for example a user gets one free list and then has to pay for the next, or for example if the method of “proxy phone” is used, since by using different identities users can cheat the number of limitations. Therefore, preferably the system uses various heuristics in order to try to automatically catch suspect duplicates: For example, if the e-mail starts with the same or a very similar name on the left side of the “@” and/or if the name is similar and the birth date is the same or very similar, preferably the system checks if other data are also similar (such as for example area and other important background data, or for example some numerical function of the general similarity between the suspected duplicate profiles), and then automatically decides if the data is similar enough to decide that it is the same person. If it is, then the system preferably automatically uses the new data as an update of the older data and preferably also notifies the user about it. If the system is less sure, then preferably it asks the user if he/she is indeed the same person and/or reports it to a log for human decision and/or warns the user for example that various sanctions will be taken against people who deliberately try to mislead the system.

18. Another possible variation is to use the data from the compatibility questionnaires filled by the users to create “group compatibility”—which means creating a group of compatible people. One of the possible ways to accomplish this is for example by running the following algorithm with at least some of the following steps: 1. First one or more individual is chosen that fulfill some required criteria. 2. Assuming that for example one female was chosen, the computer preferably now finds one or more males highly or most compatible with her (preferably by reciprocal compatibility) and adds them to the group (This finding of most compatible dates can be done on the fly or by using for example the previously generated list of most compatible dates that each person has). 3. For each of the males last added to the group the computer preferably now finds one or more of the females highly or most compatible with them (on condition that they are not already in the group) and adds them also to the group. 4. The computer now preferably finds one or more of the highly or most compatible dates for each of the recently added females, then for the newly added males, and so on, until the required group size has been reached. When finding the highly or most compatible date or dates for each newly added member, the computer can for example either take each time the next most compatible date for that person, or take into consideration for example also how compatible the new candidate is with the other members of the opposite sex that are already in the group (for example on average). This is useful for example for creating meetings or parties or virtual meetings for groups with high group compatibility. Of course this is just an example and many other variations or combinations can also be used.

19. Another problem is that to the best of my knowledge in the state-of-the-art computer dating systems there are no provisions for logical relations between the various questions other than logical “AND”. In other words, although each question can preferably be given an importance level (or 0 importance) by the user, the default relation between each two questions is automatically only “AND”, so that the system by definition lowers the score for the potential date if he/she fulfills only some of the requested traits of non-zero importance to the user. This does not allow the user to define also alternate relations between the various questions (or traits), such as for example “OR” relations or “IF” relations. So preferably the user is also allowed to define such relationships. For example, if some girl wants guys that have a white-collar job such as for example Medical Doctors, Lawyers, Accountants, Engineers, etc., and wants that the guy will be someone who works in any of these fields but does not care which of them it is, there is no way to define this in normal computer dating systems, since marking for example a high importance that the guy will be someone working in each of these jobs will lower the score to anyone that works only in one of these areas and not in all of them. So preferably the user is allowed to add an “OR” mark to each member of the requested group of traits or for example graphically pull them together into a common area. Another example is if the girl for example wants only someone who is interested mainly in the Humanities fields of interest or mainly in Technical fields of interest, etc. Preferably, defining an “OR” relationship does not override the “AND”, so that if the potential dates satisfies more then one of the questions in the “OR” group, a special bonus is added to the score. (Another possible solutions is, of course, for example to add additional questions, in this example, about wanting someone with a white-collar status and/or about higher levels of categorization of fields of interest/vocation, but obviously this would not really solve the problem since individual users might want specific combinations that are specifically important to them, and the questionnaire cannot incorporate in advance all such possible special requests). An “IF” relation is needed for example if the user wants to define that some condition can be for example automatically relaxed or tightened if another condition is met. For example, a user might define with Absolute importance that the date will have a high IQ and also define with Absolute importance a minimum Education of M.A., but for girls that have an extremely high IQ he is willing to accept them also for example if they have only a B.A. Or someone for example wants in general only thin or medium-weight girls, but if they have a very large bust he is willing to accept also fat girls. Or for example someone can define that he/she wants a date that actually works in music only if that date also marked in the questions that deal with music for example that he/she likes music of the 60's and 70's and not classical music. So preferably, for such cases the system allows the user to define also such dependencies, for example by letting the user define at the end of the questionnaire a set (or sets) of rules that can create changes in various requirements in case certain other requirements are met. This can be accomplished for example by letting the user graphically connect certain different variations of filling a certain question with certain options in another question, or for example allowing the user to define a set of “If then” sentences for example after finishing the normal filling of the questionnaire. This way the users can have much more flexibility in defining more complex relationships between various questions or sets of questions. However, the ability to add “IF” relationships is less important than “OR”, since “OR” relationships represent something that is very different from the ordinary “AND”, whereas “IF” might typically be needed only in a few rare cases. So for example in the music example given above, the user might simply mark with high importance that he/she wants someone who likes music of the 60's and 70's and not classical music and also mark with high importance that he/she would like a potential date that works in music, and this already increases the chance of getting a date who satisfies both requirements.

20. Another preferable variation is that when the user makes changes in one or more questions, he/she is preferably immediately allowed by the system to see for example an indication of the direction and extent of the change in results that this will cause. This can be done for example by automatically running the user against other potential dates upon each change in a question, but for efficiency reasons preferably this can be done for example by using general statistics of the answers by the opposite sex members to each question. So for example if the user first marks that he wants girls with medium or large bust and he had for example 500 hundred potential dates with compatibility scores above 80%, and then changes it to include only girls with large bust, or changes for example the requirements for high intelligence and/or changes the importance for these questions, the system can for example predict immediately more or less some general estimate of the amount of increase or decrease in the number of potential dates this is likely to cause (by simply using for example the statistics of the percent of girls that will be dropped by this change, preferably together with an estimate of the amount of drop or increase in scores that each level of importance marked by the user typically causes) and display it for example graphically to the user. Of course, this estimate can be wrong, but in general it can preferably give a rough estimate of what will happen after the changes, and then, for example after finishing a group of changes, the user can request an actual matching run and see the actual effect of the change. Another possible variation is to give the user feedback of results already during filling the questionnaire, so that for example after filling each question the user is given for example the choice to view similar information as described above, preferably based on statistics, since otherwise it might be very inefficient with a large database of potential dates. Another possible variation is to allow the user to request a run on potential dates for example after having filled only part of the questionnaire, or at least after having finished a section of the questionnaire (for example background data, appearance, interests, etc) however in this case preferably there are various restrictions, for example such as those described in clause number 5 above, in order to encourage the user to complete filling the questionnaire before he/she can gain full access. In such a case preferably the questions are arranged, for example within each section of the questionnaire, or across the entire questionnaire, according to descending order of importance (for example by using data from previous users), so that the results can be more meaningful even after filling only a subset of the questionnaire.

21. Another possible variation is to automatically analyze the user's answers during filling the questionnaire, in order to check the quality of his/her answers and preferably give the user feedback if the answers are not reasonable enough. This feedback can be given to the user for example during the filling process and/or after he/she has finished it and/or at least after various stages have been completed. Preferably the user's answers can be rated for example based on the optimal levels that he/she chooses, the acceptable levels on which he/she is willing to compromise, and the importance he/she gives to the question. So for example the user's choices can be defined as sufficiently discriminating or distinctive or differentiating if he/she has shown sufficient variation (for example in any of the above criteria—such as for example different levels of importance, various optimal levels or ranges, various acceptable levels or ranges or at least in some of them) among his answers about the various questions, if he/she has shown sufficient resolution (for example if he/she used all the possible levels, for example of characterization and/or all the possible weights—preferably across the questions), and/or used a sufficient range of levels (for example of characterization and/or of weights). Another possible variable is consistency—which checks for example if he/she used similar characterizations and/or weights for questions which are known to be similar or highly correlated. For example if someone wants very smart females but wants them to have only low education, or vice versa, this doesn't make sense. Another possible variable is coherence, which means for example the correlation between importance and the range of acceptable levels and the position of the optimal level (or levels). For example the more important a question is, the less reasonable it is to mark only levels in the middle without reaching one of the extreme options (one of the edges of the scale), although this might depend also on the specific content of the question. Also, if the user for example consistently uses high importance together with a wider range of acceptable levels than in low importance questions, it can be for example brought to his attention that this is not reasonable. Or the user can be warned for example if he/she gives too many questions absolute or high weight or gives too many questions weight 0. In such cases, and preferably depending on the case, the system can for example advise the user to correct specific unreasonable answers and/or to correct answers in general, and/or for example to consult with a human counselor about this. Of course various combinations of the above and other variations are also possible.

22. Although the system preferably requires the user to answer all the questions in the compatibility questionnaire, another possible variation is that, if the user did not answer some questions, the system handles the missing values for example by taking into account the average or most frequent answers in each question that the user did not answer. However, if this is done, preferably the system takes into account also the correlations of each missing answer with other answers, thus taking into account for example the other variables that are most in correlation with the missing question, such as for example sex, age, education, etc. Another possible variation is to give a lower score for matching on missing values, in a way that reflects the uncertainty. Of course various combinations of the above and other variations can also be used.

23. Another problem with large dating sites is that only a small percent of clients pay (typically just 10% or even considerably less) and in order to extract payment the sites typically offer only a very limited service to people who don't pay, so that for example they cannot contact anyone and they can only be contacted by the small percent of people who paid, and therefore the total quality of service is much below the true potential. This is typically because the sites try to charge too much from each paying client, such as for example $15-20 per month. Therefore, preferably the site charges a considerably lower fee that can encourage much more people to pay for the service, for example just $2 a month or $5 a month, and preferably the charge is done for example automatically through the user's ISP (Internet access provider), preferably without indicating to the ISP that this is a charge for a dating site (in order to preserve privacy), so that the user doesn't even feel the payment.

Another possible embodiment of this invention is to use at least some of the above features in a normal preferably Internet computer dating service, preferably with the additional requirement that each user must also supply a phone number (preferably with the option of requesting “protected phone” as described above) and preferably also an instant messaging id if available. This is preferably done together with reciprocal compatibility search, since people are more willing to give the phone if they know that the people that get them also fulfill their own expectations. The feature of automatic notification (described in clause 15 above) in this case (without instant messaging and contactee lists as an inherent part of the system) is preferably done for example by sending the person that requested the notification an automatic e-mail message about it, or SMS, (or for example an automatically generated phone-call, preferably if he/she pays for it), preferably including the phone number (or proxy-phone number as a code or a link without code) of the new person (preferably in addition to the new person's e-mail, and preferably also IM number, if available), so that the person receiving the notification can also contact the new person immediately. This is in contrast to the state of the art, in which users are updated only on a periodic basis or when they perform a search. Another possible variation is that, at least for users that gave also an IM id number, the system tries to find out if they are currently Online for example through an element that contacts the relevant server, and if so, when showing a potential date's data on a dating search results list, the system preferably shows also his/her IM id number, the IM network that it belongs to, and an indication if he/she is currently Online, so that the user can instantly contact him/her through the appropriate IM client program. Another possible variation is that being Online can be defined by at least one of the following two conditions: A user has logged into the system with his/her user name and password not longer than a certain time ago, b. A user has performed at least 1 activity in the system not longer than a certain time ago. Another possible variation is that the system allows users to send to persons who are currently online according to the above definition instant messages for example by displaying a preferably visibly conspicuous messages to the person for example the next time he/she tries to access pages on the system (for example any page, or most pages or the menu) (this can be done for example by generating a page on the fly when the system recognizes by browser cookies that this is the person for whom the message is intended) and preferably one of the options on this generated page is for example to press a link that enables the users to enter a chat channel. Another possible variation is that some or all of the pages on the dating site have an automatic refresh instruction (for example once every minute or every few minutes, for example through an html tag or through Javascipt or ActiveX, if the browser supports it) and the user simply has to leave at least one window of the browser open on the site (and it is preferably recommended to do so in the instructions for users on the site) and the user can for example go on sliding in other windows, and when there is a notification for him/her, then it is included automatically in the next refresh, preferably with the addition of an audible sound that can get the user's attention. If it is done for example by Javascript or ActiveX, preferably the Javascript or ActiveX can also check for example if the user continues to actively use the browser (in order to be able to apply more efficiently the activity rules to check if the user is still Online), and when requesting the refresh the browser can for example transfer an additional parameter to the requested url that represents the Online status of the user. If it is ActiveX, this can be even more comprehensive, because the ActiveX can preferably know for example if the user typed or clicked anything at all and not just used the browser. This has the advantage that no special client program is needed in addition to the browser. Of course, adding additional IM features to an online computer-dating service can make it equivalent to adding Computer Dating features to IM networks. Preferably the Online status of dates in the list of compatible dates is automatically updated if it changes while the list is still open (for example if the user has kept the window of the list open or has previously saved it and reopens it), for example by automatic refresh, for example every minute or more or less. Another possible variation is that in order to save bandwidth for example the html protocol is changed so that it is possible to define “refresh on a need basis”, which means that the refresh command is initiated automatically by the site when there is any change in the preferably dynamic page (so that the browser can get a refresh even if it didn't ask for it), or for example the browser asks for refresh more often (for example every 20 seconds or even less), but if nothing has changed then the browser gets just for example a code that tells it to keep the current page or window as is. The first of these two variations is more preferable since it saves the waste of bandwidth by unnecessary refresh requests by the browsers. In addition, when the refresh is sent, preferably it can be a smart refresh, which tells the browser only what to change on the page instead of having to send the entire page again. Another possible variation is to implement this “refresh on need” for example by active X and/or Java and/or Javascript and/or some plug-in or other dynamic code that is updated only when there is a need for it. Another possible variation is for example to keep the page open like a streaming audio or video so that the browser always waits for new input but preferably knows how to use the new input for updating the page without having to get the whole page again. These features are even more important for example for the implementation of the instant messaging and/or the automatic notification if it is done with automatic refresh, in order to increase efficiency and speed of communication. Of course, like other features in this invention, the above features or variations can be used also independently of any other features of this invention. Preferably, this method can also be used as an additional option for the automatic notification. Of course, various combinations of these variations can also be used.

FIG. 1 shows a preferable way in which the user fills the questionnaire as a plug-in or add-on within an instant-messaging client program. When the user activates the client. (11), the system first checks if the user has already been registered in the system and, if not, gives him/her a new unique user id, and/or the system can also use for example the id that the user has in the network in which he/she is a member together with a code of the network. (This check can be done either by checking locally on the user's computer or by checking on our server(s) on the Internet) (12). If the user hasn't filled the questionnaire already, he is asked to fill it, including preferably his self-description, description of the ideal date, and the importance for each question (13).

Then, if the user has made changes or has filled the questionnaire for the first time, the user's data is saved, preferably both on the user's computer and on our servers(s) on the Internet in a static database of all users who filled the questionnaire or in a dynamic database of users currently online (14). After this, the user continues to work with the instant messaging client (15).

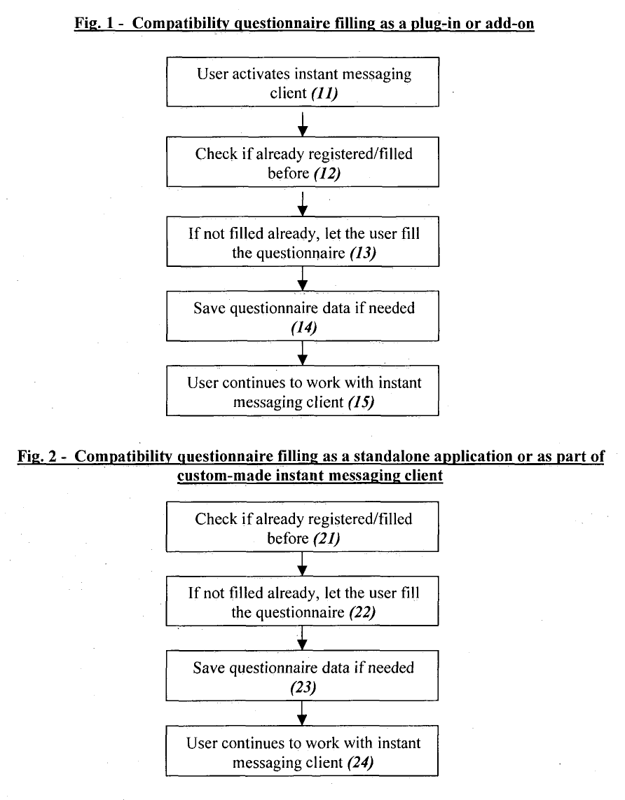

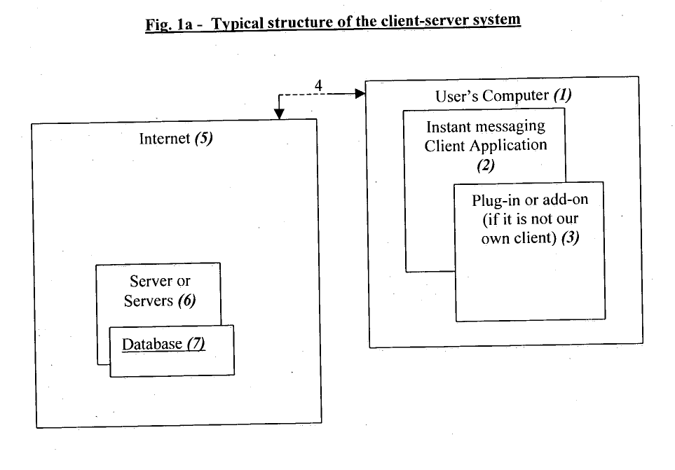

FIG. 2 shows a preferable way in which the user fills the questionnaire as a standalone application or as part of custom-made instant messaging client. First the system checks if the user has already been registered in the system and, if not, gives him/her a new unique user id, and/or the system can also use for example the id that the user has in the network in which he/she is a member together with a code of the network. (This check can be done either by checking locally on the user's computer or by checking on our server(s) on the Internet) (21). If the user hasn't filled the questionnaire already, he is asked to fill it, including preferably his self description, description of the ideal date, and the importance for each question (22). Then if the user has made changes or has filled the questionnaire for the first time, the user's data is saved, preferably both on the user's computer and on our servers(s) on the Internet in a static database of all users who filled the questionnaire or in a dynamic database of users currently online (23). After this, the user either activates the instant messaging client program which is coupled to the search plug-in or add-on (if the standalone filling application works in conjunction with the existing main instant messaging networks) or continues to work with the standalone's own instant messaging client (if it is part of our own instant messaging client) (24).

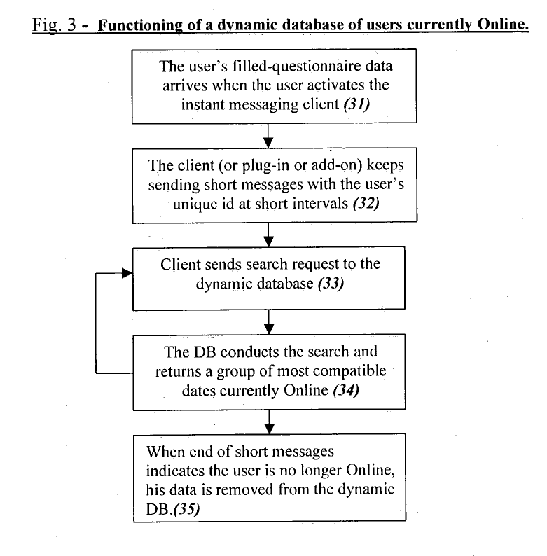

FIG. 3 shows a preferable way in which the dynamic database of users that are currently Online works. As soon as the user opens the Internet connection and activates the instant messaging client (which is either our own client program or the client program of one of the common instant messaging networks with our custom-made plug-in or plug-ins or add-on or add-ons), preferably a message is sent to the dynamic database server(s) containing the user's filled compatibility questionnaire data (31). Then our client or the plug-in or add-on coupled to the client preferably keeps sending at short intervals a short message to one of our servers containing the user's unique id so that the system can tell if the user is still logged-in (preferably these short messages are sent either to the Database server itself or to another server, which will in turn notify the database server if the messages stop coming) (32). (of course, if it is a plug-in or add-on to an existing client program, it is also possible to get such info by letting our server query the normal server of the client, but that is less efficient and might be for example blocked by the normal server of the client). Another possible variation is for example instead of using short messages at short intervals, for example to rely on some automatic logoff signals, however since that is less reliable, such a method is preferably accompanied for example by automatic notification to the server and/or to other clients whenever attempts (for example by the server or by any other client) to communicate with the user who is still supposed to be online show that he/she is no longer online. In other words: The IM server is automatically informed by other IM clients if they try to reach a client that is considered Online but don't succeed and thus the IM server can assume that that IM client is no longer Online, and/or assumes so if the server itself does not succeed to connect to that client. Similarly, preferably if the server and/or other clients receive communications from a client that was considered to be offline, the receiving clients report it to the server and the server updates its status to Online. If automatic logoff signals are used, preferably the client software creates a hook or interface with the communication software and/or with the routines that are activated when the OS (Operating System) is shut down so that when the user closes the client software and/or the Internet connection and/or shuts down properly the OS, the client software can still first send to the IM server a message that the user has logout out, before letting the connection to actually be closed. However, since the user might for example turn off the computer through the power switch or through pressing reset (without properly shutting down the OS or the connection), the above automatic notification is preferably also used. Of course, these alternative methods of determining if a user is still Online can be used also in combination with any other variation in this patent. When the user requests an instant dating search (For example with his profile in a 2-way compatibility search or as a 1-way search or search for a small group of qualities, for example—find all the blondes with highest IQ who are currently logged in, or find them for example only if the reciprocal compatibility score with them is above a certain percent; Other search options can be for to example find only dates with a minimum compatibility score requested by the user, but preferably the user cannot request a minimal score lower than a certain minimum required by the system as the minimal acceptable compatibility score), the client sends the appropriate request to the dynamic database (33). The dynamic database will make the search accordingly and send back the list of most compatible dates that are currently connected, preferably including various details about them according to the type of search. The user may also add any of them to his/her contactee list and can be notified immediately when they are Online again (34) in a similar way to the description of 44. When the short messages from the client cease reaching the appropriate server, indicating that the user is no longer connected, his data is removed from the dynamic database (35).

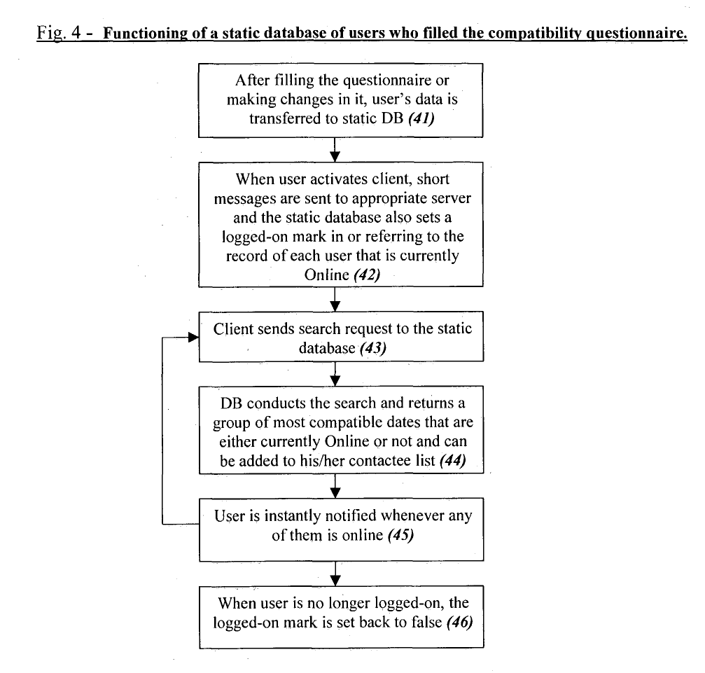

FIG. 4 shows a preferable way in which the static database of users that filled the compatibility questionnaire works. After the user finishes filling the questionnaire or makes changes to it, his or her data (including also his name, e-mail and unique user Id) is transferred to the static DB (41) and is preferably saved also on the user's computer. As soon as the user activates the instant messaging client, preferably short messages are again sent to the appropriate server as in FIG. 3, and the static database also preferably sets a logged-on mark in the record of each user that is currently logged-in on the Internet (This mark may be also set for example at a separate file or index or pointer in addition or instead, and held for example in RAM memory for maximum access speed, or on the disk, or both) (42). When the user requests a dating search (again, for example 2-way compatibility or 1 way search or search for just certain attributes), preferably he/she may also choose if he/she wants to search for all compatible dates or only those that are currently Online. (If the user wants to search only for people who are currently online, preferably he has the option of choosing for example a maximum time that elapsed since someone was online or the minimum average frequency that someone is online) (43). The list of most compatible dates (again, preferably, with various details) can be added to the user's list of contactees in the instant messaging client (if it's our own client or the contactee is a member of the same network) or to a special list maintained by the plug-in or add-on (if it is a plug-in or add-on coupled to one of the common instant messaging clients). Preferably, the user has a choice of marking which of these compatible dates to add to his contactee list or which of them to remove. (44). If any of these chosen compatible dates becomes Online, the user is preferably immediately notified about it (45). When a user is no longer online, his/her on-line mark or marks are set again to off (46).

FIG. 5 shows a preferable way in which the compatible-date search application works as a plug-in or add-on within an instant messaging client. When the user wants to search for new compatible people, he/she chooses within the plug-in or add-on for example if he/she wants to execute a 2-way compatibility search or just search for people with certain qualities (and also if to search only for people currently Online, if it is a static DB) (51). The plug-in or add-on then transfers the search request to the appropriate DB server (Which can be for example static, or dynamic, or both) and then displays the results to the user as explained in FIGS. 3 and 4) (52).

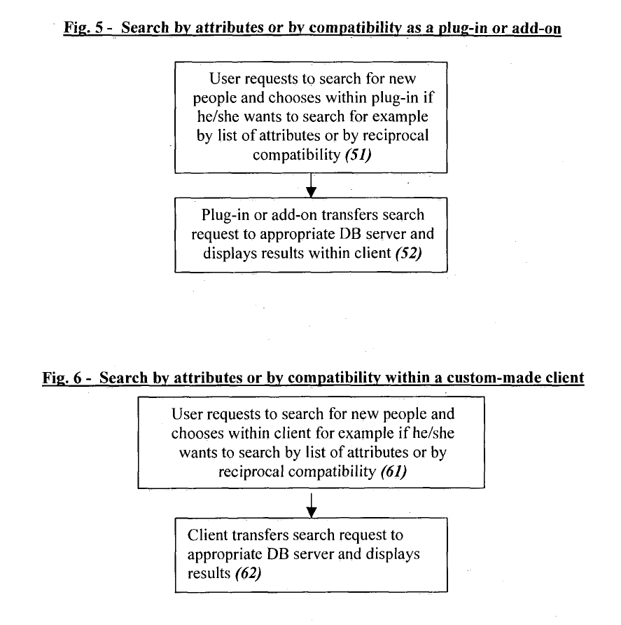

FIG. 6 shows a preferable way in which the compatible-date search application works within a custom-made instant messaging client (in other words—our own client). When the user wants to search for new compatible people, he/she chooses for example if he/she wants to execute a 2-way compatibility search or just search for people with certain qualities (and also if to search only for people currently Online, if it is a static DB) (61). The client then transfers the search request to the appropriate DB server (Which can be for example static, or dynamic, or both) and then displays the results to the user as explained in FIGS. 3 and 4) (62). This custom-made client can be either a stand-alone application, or work as a plug-in or add-on within another Internet application such as for example one of the big browsers (such as Netscape or Microsoft Internet Explorer), or be an integral part of it. (Of course, the plug-in or add-on described for example in FIG. 5 can also be for example coupled to a client which is itself for example coupled to a browser or an integral part of it).

FIG. 7 is a schematic diagram of a preferable way that the add-on can for example let the client or part of the client act as if it is communicating with another client of the same network or with its server, but translate the communication to another protocol and/or redirect it to the other network. When the user's client program is trying communicate in its normal protocol, for example ICQ, with the normal interface of its chat windows (71), if the plug-in or add-on sees that the communication is actually intended for or coming from a client of a different network, for example MSN (72), it preferably steps-in and converts between protocols as needed (73). If it's an outgoing communication the add-on or plug-in preferably redirects the output to the appropriate server or client of the other network as needed. If it is an incoming communication it preferably translates it into the protocol that the client program expects to see and makes the client think that this communication came from its own network. In order to enable this, preferably all the contactees that are not really members of the client program's IM network are specially marked by the plug-in or add-on, So that it can intervene when the user's client program is trying to communicate with them.

FIG. 8 is an example of a preferable way that the extended contactee list can look like. In the example shown the order is to show first contactees that are available for dating, then friends or other contactees not related to dating (marked with “N/A”=Not Applicable), and then people who were found in the context of date searching but are now no more interested or available for dating. In this example this group is preferably last since the user is probably least likely to want to contact them. Inside each group the order can be for example alphabetic and/or based on the most recent activity and/or on putting the persons with the longest contact history with the user on top, or any combinations of this, as explained in the reference to this in FIG. 1a. (“comm.” stands for communications with the user). When someone is not available preferably he/she changes his/her status on his/her client, which then preferably propagates automatically to update all the other contactee lists where that person is listed. This is like having a computer dating output list which is updated in real time (or when the user is next Online) whenever there is any change in the status of the persons on the list. In this example “*F” means found someone through the service, “*E” means found someone elsewhere, “*TF” and “*TE” mean this new status is only temporary, “*FM means found someone trough the service and got married”, “*EM means found someone not trough the service and got married”, “*T means temporarily unavailable, etc. Of course other status options and codes can be used instead or in addition. For implementing for example the reporting on most frequent activity hours (activity in the IM network), preferably the statistics are gathered for each user by his/her own client program and sent to the server, in order to save time and not unnecessarily burden the server or servers. Preferably, the various times data are displayed in terms of the user's local time zone (for example by taking into account the different time zones between the user and the contactee and automatically adjusting it). Preferably the compatibility scores (as reported in the search results list) with each person in the contactee list are also saved automatically when the person is added to the contactee list, so that the user can click on or near the contactee in order to get for example a reminder of these scores, and/or view also the contactee's profile or at least part of it. Of course this is just an example and other orders can also be used, as explained for example in clause 2 of the reference to FIG. 1a.

FIG. 9 is an example of a preferable way that the list of most compatible dates following a reciprocal compatibility search can look like. Since there are preferably a serious number of questions (such as for example 100 or above) for enabling really systematic matching, it is impractical to show the full profile of the date to the user, and it is also undesired because: A. some questions or types of questions (such as in the area of personality for example) are preferably kept discrete, otherwise people will not answer them honestly. B. With such a large number of questions people have a problem analyzing and integrating all this information, so detailed compatibility scores plus a list of most important fulfilled expectations can help the user see the picture very efficiently. Another possible variation is for example to let the user click on the date in order to get his/her profile, but the profile is preferably shown without the questions marked as discrete or confidential. Another possible variation is that when the user requests to see the date's profile, he/she is shown only the answers the date gave on the questions most important to him/her (preferably with the additional limitation that in any case this does not include questions that are considered discrete or confidential). For this reason preferably in the questionnaire itself the questions that are considered discrete and confidential are preferably marked differently. (Another possible variation is that the user can also mark for example up to a certain amount of questions as confidential while filling the questionnaire or correcting it, or can mark questions in certain section as confidential if he/she chooses, but this is less desirable since it can make filling the questionnaire more cumbersome). This is just an example of a possible way of ordering the results. Another possible variation is for example to list the Online and Offline users together in descending order of compatibility scores, and just add a mark, or indicate for example by different color if they are online or offline. For example, dates who are currently online can be marked in a bright color, dates who are offline but have recently been online are marked in a darker color, and dates who have not been online for example for a few months (a limit which preferably can be determined also by the user), are marked for example in gray. Of course, more than 3 levels can also be used. This is more useful for people who want to seriously find a date and don't care if he/she is currently online or not, whereas people who prefer for example to chat with a compatible date right now will probably prefer the option that lists them separately. Therefore, preferably the user can choose which of these options to use. Other issues of ordering the results and of search and sorting options were discussed in the reference to this in FIG. 1a above. Another possible variation is that the user can also save this list for later reference, and if there is change for example in the availability for dating of any of the persons in the list or for example in their geographical/physical vicinity, it is preferably updated automatically in a way similar to the way that this status can be updated automatically for people in the contactee list, as explained in the reference to FIGS. 1a & 8. Another possible variation is that after looking at the list the user can for example mark persons whom he/she doesn't want to show up again in future searches (this set of marked persons can be saved for example on the client or on the server or both). Also, other variations are possible, such as for example showing on the results list more concise data on each person that is expanded (for example into a separate window) if the user clicks on that person, or displaying for example a few separate sets of concise results for example for each geographical area that the user requested, etc. Of course various combinations of these and other variations are also possible.

While the invention has been described with respect to a limited number of embodiments, it will be appreciated that many variations, modifications, expansions and other applications of the invention may be made which are included within the scope of the present invention, as would be obvious to those skilled in the art.

I claim:

1. A System for searching, finding and contacting dates on the Internet in instant messaging networks, comprised of at least the following elements:
a. A Client program, located on the User's computer;
b. At least one Server, located on the Internet;
c. At least one module for filling and/or making changes to a computer dating compatibility questionnaire;
d. A search module for finding potential dates which can check also if they are currently Online;
e. At least one of: An ability to search also for dates who are not currently Online, and The ability to search for dates based on reciprocal compatibility;
f. An instant messaging element which knows if the user is currently Online, and also enables instant exchange of messages between users.

2. The system of claim 1 wherein said system is part of a custom-made instant messaging client, or at least part of the system is an add-on or plug-in, which can be coupled to at least one of the client programs of existing instant messaging networks.

3. The system of claim 1 wherein the filled questionnaire data is saved on at least one of:
a. Locally on the user's computer,
b. A dynamic database which contains users' data only as long as they are Online.
c. A dynamic database which contains users' data only as long as they are Online, but at least the user's unique ID is saved also in a static DB on the server.
d. A static database on a server on the Internet, and each user's record is marked as Online as long as the user is Online.
e. A static database on a server on the Internet, and each user's record is marked as Online as long as the user is Online, and the user can search also for persons not currently Online and add them to his contactee list.
f. The user can be notified immediately at least for some contactees when they become Online.

4. A method for searching, finding and contacting dates on the Internet in instant messaging networks, comprised of at least the following steps:
a. Using a Client program, located on the User's computer;
b. Using at least one Server, located on the Internet;
c. Using at least one module for filling and making changes to a computer dating compatibility questionnaire;
d. Using a search module for finding potential dates which can check also if they are currently Online;
e. Using at least one of: An ability to search also for dates who are not currently Online, and The ability to search for dates based on reciprocal compatibility;
f. Using an instant messaging element which knows if the user is currently On-line, and also enables instant exchange of messages between users.

5. The method of claim 4 wherein said system is part of a custom-made instant messaging client, or at least part of the system is an add-on or plug-in, which can be coupled to at least one of the client programs of existing instant messaging networks.

6. The method of claim 4 wherein the filled questionnaire data is saved on at least one of:
a. Locally on the user's computer,
b. A dynamic database which contains users' data only as long as they are Online.
c. A dynamic database which contains users' data only as long as they are Online, but at least the user's name, e-mail, and unique ID are saved also in a static DB on the server.
d. A static database on a server on the Internet, and each user's record is marked as Online as long as the user is Online.
e. A static database on a server on the Internet, and each user's record is marked as Online as long as the user is Online, and the user can search also for persons not currently Online and add them to his contactee list.
f. The user can be notified immediately at least for some contactees when they become Online.

7. An Online computer dating system wherein the system knows if users are currently online by at least one of:
a. An integration with an Instant Messaging system, as in claim 2.
b. For users that gave also an IM id number, the system tries to find out if they are currently Online, and if so, when showing a potential date's data on a dating search results list, the system shows also his/her IM id number, the IM network that it belongs to, and an indication if he/she is Online, so that the user can contact him/her through the appropriate IM client program.
c. For users that gave also an IM id number, the system tries to find out if they are currently Online through an element that contacts the relevant server.
d. Being Online can be defined as at least one of: a. A user has logged into the system with his/her user name and password not longer than a certain time ago, b. A user has performed at least 1 activity in the system not longer than a certain time ago. c. The user continues to actively use the browser. d. A user's computer is connected to the Internet and the user is active at the computer.

8. The system of claim 7 wherein at least one of the following elements is added to the contactee list near each contactee: Sex, Age, Area, compatibility scores, Last Date and time of Activity, Most frequent activity hours and/or day parts and/or week days, How often the person is usually Online, Last Communication date with the user, Number of communications so far with the user, and Dating availability Status.

9. The system of claim 8 wherein the contactee list can be sorted by at least one of the elements listed in claim 8, and the sorting order is based on at least one of these elements.

10. The system of claim 7 wherein at least one of the following features exits:
a. The user can have at least one of the following additional abilities: Knowing how many other users have him/her in their contactee lists, Knowing at least the e-mails of these users, and being able to broadcast messages to them.
b. Whenever a user changes his/her Dating availability Status it is automatically updated in all the contactee lists wherein that user is listed.
c. Each user can also remove himself/herself automatically from all the contactee lists where he/she is listed and/or at least block certain users by at least one of being deleted from their contactee lists and making the system never let them know that the user is online.

11. The system of claim 7 wherein at least one of the following features exist:
a. The user can choose in each search at least one of the following search options: a. Reciprocal compatibility Search based on the self descriptions and preferences and importances in the questionnaires of both the user and the potential dates; b. 1-way compatibility search based at least on the data of preferences and importances of the user's questionnaire; and c. Attribute search, based on marking for the search a small number of attributes that are used as necessary conditions or marked with importances and using at least these preferences.
b. At least in one of the non-reciprocal search options, the user's own self description data is also taken into account at least partially.
c. The user can request and get a list of date-search results that show the most compatible potential dates in descending order of compatibility, and near each potential date is marked if he/she is currently Online, and, if not, at least one of: When was the last time and date he/she was Online, When he/she is most frequently Online, and How often he/she is usually online.
d. In a list of dates with descending order of compatibility, potential dates that are Online are marked by at least one of the group: {Special color, Special shape of text, Special size of text, and Special icon}.
e. Potential dates that are not currently online but were recently Online are marked less conspicuously, and potential dates that are not currently Online and also were not recently online are marked even less conspicuously.
f. The user can request and get a list of date-search results that is divided at least into the following sub-lists and within each sub-list the dates are ordered by descending compatibility scores: A sub-list of currently Online dates, a sub-list of dates that are not currently Online but were recently Online, and a sub-list of dates that are not currently Online and also were not recently Online.
g. The user can request and get a list of date-search results that is divided at least into the following sub-lists and within each sub-list the dates are ordered by descending compatibility scores: A sub-list of currently Online dates, and A sub-list of dates that are not currently Online.
h. If the potential date is not currently Online, the last time and date he/she was online is listed near his/her details.
i. If the user is accessing the server from a Client program on another computer, he/she can still access at least his/her questionnaire data and contactee list from a copy kept on the server, by supplying appropriate password/identification.
j. The user can send instant messages to potential dates who are currently Online and/or enter chat with them.
k. If a user's compatibility scores are generally low beyond a certain criterion, the system can report to the user the list of questions that most contributed to the problem.
l. Each two users of the system can also check the exact compatibility between them.

12. The system of claim 7 wherein at least one of the following features exist:
a. After at least 1 of: {a. A user hasn't been Online for a certain time period, b. A user hasn't been active in the system for a certain time period, and c. Another user submits a form reporting that some user is no longer interested in dating}—the system can generate an automatic message to him/her to ask if he/she is still interested, and if an appropriate reply does not come back after a certain additional time and after at least 1 attempt, the system automatically “freezes” that user until he/she shows activity again.
b. The system disregards reports by other users that some user is no longer interested in dating if at least one of: The user in question has been recently Online, and The user in question has recently performed a dating-search.

13. The system of claim 7 wherein at least one of the following features exist:
a. Everyone must include also his/her phone number so that they can be contacted by phone.
b. If the user does not want his/her phone number exposed to other users without control, he/she can mark his/her phone as “protected”, which means that other users access his/her phone only through the system without knowing the real number, until the user decides to give them the actual number.
c. “Protected phones” can at least one of: Be accessed only at reasonable times that can be defined by the system and/or by the user, Be accessed by each user only a limited number of times, and Be accessed until blocked.
d. When dialing to a protected phone the call is done by at least one of: 1.
Direct activation though the client program—if it is done from a cellular phone connected to the Internet, or from a computer with a microphone and sound card, 2. Through phoning a special number and then clicking the code, and the server there automatically routes the call to the real number.

14. The system of claim 7 wherein at least one of the following features exist:
a. In questions of the dating questionnaire where there is a mismatch between the self-description and the preference of the person being matched against, the system can take into account also at least one of: The size of the gap/distance, and The direction of the gap/distance.
b. Matching by area takes into account in addition to the self-areas and desired areas marked by the users, also at least one of: The difference in zip-codes, and The similarity in the first digits of the phone numbers, if both phone numbers being compared are not mobile numbers, in order to further refine the scores.
c. Matching by area takes into account at least the distance in at least one of GPS data and other absolute Geographical coordinates.

15. The system of claim 7 wherein users can be notified automatically whenever someone new fitting at least one criterion has at least one of: {a. Sent his/her data to the system, b. Sent his/her data to the system and is currently Online, c. Performed a compatibility search for the first time}, and said notification is by at least one of: Sending an appropriate e-mail message to the user, Sending an appropriate instant message to the user, Adding the new dates directly into the user's contactee list, Automatic phone call to the user, Sending an SMS message to the user, Adding the new compatible date automatically to the user's contactee list, and Adding the new compatible date automatically to the user's contactee list if the new date is especially important.

16. The system of claim 7 wherein at least one of the following features exist:
a. Users connected through cellular devices can be notified automatically as soon as someone fitting a certain criterion is close to them below a certain distance, and this distance is known through at least one of: The cell system, Short-range wireless communication between the cellular devices themselves, Geographical coordinates, and Other methods.
b. The user can request and get at least as one of the search options a list of date-search results that is divided at least into the following sub-lists and within each sub-list the dates are ordered by descending compatibility scores: A sub-list of dates that are in an area close to him/her, and a sub-list of dates that are in an area less close to him/her.
c. Among users that have cellular devices, at least one of the search option is to put dates that are close to the user according to at least one of: {being in range of short range wireless communication, the info from the cells, and geographical coordinates} in a higher list than dates that are not that close.
d. The user can request and get at least as one of the search options a list of date-search results in descending order of compatibility, in which dates that are closer to the user are marked more conspicuously.
e. Users that are connected through cellular devices can initiate a request to check if there are any available dates within range of short distance wireless communication.
f. Users that are connected through cellular devices can initiate a request to check if there are any available dates within range of short distance wireless communication, and if the person is available and a member in the system, the user can also view at least one of: some background data about him/her, and the appearance data about him/her in order to be able to know if it refers to the person he/she is looking at.
g. Users that are connected through cellular devices can initiate a request to check if there are any available dates within range of short distance wireless communication, and the user can include screening criteria in advance so that only nearby phones who's users fit the criteria respond to the query.

17. The system of claim 7 wherein a systematic data pool of pictures of males and of females is used so that each user can at least one of: {mark at least 1 picture that is most similar to himself/herself, and mark the pictures of the opposite sex that he/she most likes}, and the pictures are at least one of: photographs and systematically drawn images.

18. The system of claim 17 wherein at least one of the following features exist:
a. The pictures are divided at least into facial pictures and body pictures and are marked separately for each category.
b. At least one of the info from marking the pictures and info from textual questions on appearance is taken into account while calculating the appearance compatibility.
c. The info from the textual questions on appearance is taken into account while asking the user to mark his/her own appearance and the appearance of the desired dates, in order to increase efficiency and save time.
d. The user is asked to make choices in a tree-like manner in order to increase efficiency and save time.

19. The system of claim 7 wherein at least one of the following features exist:
a. The client program is able to work automatically with more than one IM network.
b. At least one of: The IM client program and The elements in the client program that deal with dating, are an integral part of the browser.
c. The client program and/or the questionnaire can be updated automatically from the server when needed.

20. The system of claim 7 wherein at least one of the following is done regarding suspect duplicate records:
a. The system uses at least one of the following methods to try to automatically catch suspect duplicate records: {a. Check if the e-mail starts with at least a very similar name on the left side of the “@”; b. Check if the user name is at least very similar. C. Check if the birth date is at least very similar}.
b. If a new record is a suspect duplicate, the system checks if other data are also very similar, and then automatically decides if the data is similar enough to decide that it is the same person, and if it is, then the system automatically uses the new data as an update of the older data, and If the system is less sure, then it does at least one of: {a. Ask the user if he/she is indeed the same person, b. Report in to a log for human decision, c. Warn the user that various sanctions will be taken against people who deliberately try to mislead the system}.

21. In an Online dating system, a method wherein users can be notified automatically when someone new fitting a certain criterion has at least one of: Sent his/her data to the system, Sent his/her data to the system and is currently Online, and Performed a compatibility search for the first time.

22. The system of claim 21 wherein the notification is by at least one of: Sending an appropriate e-mail message to the user, Sending an appropriate instant message to the user, Adding the new dates directly into the user's contactee list, Automatic phone call to the user, and Sending an SMS message to the user.

23. The system of claim 7 wherein the system allows users to send to persons who are-currently online instant messages by at least one of:
a. Displaying messages to the person the next time he/she tries to access pages on the system by generating a page on the fly when the system recognizes by browser cookies that this is the person for whom the message is intended.
b. Displaying messages to the person by using automatic refresh so the user simply has to leave at least one window of the browser open on the site.

24. The system of claim 23 wherein at least one of the following features exist:
a. These instant messages can also be used as additional option for the automatic notification about new fitting dates.
b. The instant messages can also be by automatic refresh of pages.
c. At least one of Javasrcipt and ActiveX is used to tell the server if the user is still active based on user activities not related to the site.

25. In an Online computer dating service, a method wherein at least one of the following features exist:
a. Everyone must include also his/her phone number so that they can be contacted by phone.
b. If the user does not want his/her phone number exposed to other users without control, he/she can mark his/her phone as “protected”, which means that other users access his/her phone only through the system without knowing the real number, until the user decides to give them the actual number.
c. “Protected phones” can at least one of: Be accessed only at reasonable times that can be defined by the system and/or by the user, Be accessed by each user only a limited number of times, and Be accessed until blocked.
d. When dialing to a protected phone the call is done by at least one of: 1. Direct activation though the client program—if it is done from a cellular phone connected to the Internet, or from a computer with a microphone and sound card, 2. Through phoning a special number and then clicking the code, and the server there automatically routes the call to the real number.

26. In an Online computer dating system, a method wherein the system knows if users are currently online by at least 1 of:
a. An integration with an Instant Messaging method, as in claim 4.
b. For users that gave also an IM id number, the system tries to find out if they are currently Online, and if so, when showing a potential date's data on a dating search results list, the system shows also his/her IM id number, the IM network that it belongs to, and an indication if he/she is Online, so that the user can contact him/her through the appropriate IM client program.
c. For users that gave also an IM id number, the system tries to find out if they are currently Online through an element that contacts the relevant server.
d. Being Online can be defined as at least one of: a. A user has logged into the system with his/her user name and password not longer than a certain time ago, b. A user has performed at least 1 activity in the system not longer than a certain time ago. c. The user continues to actively use the browser. d. A user's computer is connected to the Internet and the user is active at the computer.

27. The method of claim 26 wherein at least one of the following features exist:
a. The user can choose in each search at least one of the following search options: a. Reciprocal compatibility Search based on the self descriptions and preferences and importances in the questionnaires of both the user and the potential dates; b. 1-way compatibility search based at least on the data of preferences and importances of the user's questionnaire; and c. Attribute search, based on marking for the search a small number of attributes that are used as necessary conditions or marked with importances and using at least these preferences.
b. At least in one of the non-reciprocal search options, the user's own self description data is also taken into account at least partially.
c. The user can request and get a list of date-search results that show the most compatible potential dates in descending order of compatibility, and near each potential date is marked if he/she is currently Online, and, if not, at least one of: When was the last time and date he/she was Online, When he/she is most frequently Online, and How often he/she is usually online.
d. In a list of dates with descending order of compatibility, potential dates that are Online are marked by at least one of the group: {Special color, Special shape of text, Special size of text, and Special icon}.
e. Potential dates that are not currently online but were recently Online are marked less conspicuously, and potential dates that are not currently Online and also were not recently online are marked even less conspicuously.
f. The user can request and get a list of date-search results that is divided at least into the following sub-lists and within each sub-list the dates are ordered by descending compatibility scores: A sub-list of currently Online dates, a sub-list of dates that are not currently Online but were recently Online, and a sub-list of dates that are not currently Online and also were not recently Online.
g. The user can request and get a list of date-search results that is divided at least into the following sub-lists and within each sub-list the dates are ordered by descending compatibility scores: A sub-list of currently Online dates, and A sub-list of dates that are not currently Online.
h. If the potential date is not currently Online, the last time and date he/she was online is listed near his/her details.
i. If the user is accessing the server from a Client program on another computer, he/she can still access at least his/her questionnaire data and contactee list from a copy kept on the server, by supplying appropriate password/identification.
j. The user can send instant messages to potential dates who are currently Online and/or enter chat with them.
k. If a user's compatibility scores are generally low beyond a certain criterion, the system can report to the user the list of questions that most contributed to the problem.
l. Each two users of the system can also check the exact compatibility between them.

28. The system of claim 17 wherein at least one of the approximate images and real photos (when available) can be used to create Virtual Reality environments where users can “meet”.

29. The method of claim 26 wherein a systematic data pool of pictures of males and of females is used so that each user can at least one of: {mark at least 1 picture that is most similar to himself/herself, and mark the pictures of the opposite sex that he/she most likes}, and the pictures are at least one of: photographs and systematically drawn images.

30. The method of claim 29 wherein at least one of the following features exist:
a. The pictures are divided at least into facial pictures and body pictures and are marked separately for each category.
b. At least one of the info from marking the pictures and info from textual questions on appearance is taken into account while calculating the appearance compatibility.
c. The info from the textual questions on appearance is taken into account while asking the user to mark his/her own appearance and the appearance of the desired dates, in order to increase efficiency and save time.
d. The user is asked to make choices in a tree-like manner in order to increase efficiency and save time.

31. The method of claim 26 wherein the data from the compatibility questionnaires filled by the users can be used also to create “group compatibility”—which means creating a group of compatible people.

32. The method of claim 31 wherein at least two of the following steps are used: 1. First at least one individual is chosen that fulfills some required criteria. 2. The computer now finds at least one potential date of the opposite sex highly compatible with the first chosen individuals and adds them to the group. 3. For each of the individuals last added to the group the computer now finds at least one potential date of the opposite sex highly compatible with them (on condition that they are not already in the group) and adds them also to the group. 4. The computer now finds at least one highly compatible dates for each of the recently added individuals, then for the newly added opposite sex individuals, and so on, until the required group size has been reached.

33. The method of claim 32 wherein when finding the highly compatible date or dates for each newly added member, the computer at least one of:
a. Takes each time the next most compatible dates for that person.
b. Takes into consideration also how compatible the new candidate is with the other members of the opposite sex that are already in the group

34. The system of claim 16 wherein the cellular device uses at least one of compass orientation and GPS info about its own position and the position of the potential date in order to point the user more exactly to the location of the potential date.

35. The system of claim 7 wherein users are also allowed to define “OR” relations between various questions, so that it is sufficient that potential dates fulfill the requirements in one of the questions in the group of questions for which the “OR” relation is applied.

36. The system of claim 35 wherein the “OR” and “AND” are combined, so that fulfilling more than one of the questions in the “OR” group adds a bonus to the compatibility score.

37. The system of claim 7 wherein users are also allowed to define “IF” relations between various questions, so that if certain conditions are met in at least one question, requirements can be changed in at least one other question.

38. The system of claim 7 wherein when the user makes changes in one or more questions, he/she is immediately allowed by the system to see an indication of the direction and extent of the change in results that this will cause.

39. The system of claim 38 wherein said indication is done efficiently as an estimate by using general statistics of the answers by the opposite sex members to each question together with an estimate of the amount of drop or increase in scores that each level of importance marked by the user typically causes.

40. The system of claim 7 wherein the user is allowed to request and view a list of all the questions that had most effect on at least one of lowering or adding to the compatibility scores, and this list is shown in at least one of descending order of magnitude and descending order of importance, and other order.

41. The system of claim 7 wherein two users can request a detailed analysis of the specific compatibility between them.

42. The system of claim 41 wherein said detailed analysis can include at least one of: the lists of questions that most contributed to or reduced their compatibility scores, a display of the level of matching on each question, and the serial position of each of the two persons on the other person's list

43. The system of claim 42 wherein at least one of:
a. The lists of questions are ordered in at least one of: the original order of the questionnaire, sorted in descending order of importance, sorted in descending order of matching, or sorted in descending order of effect on the compatibility scores.
b. The lists of questions are at least one of: separate for showing the 1-way matching to the first person and for the opposite 1-way match, and combined, so that the questions are listed only once.

44. The system of claim 7 wherein the user's answers are automatically analyzed during filling the questionnaire, in order to check the quality of his/her answers, and at least one of the user's differentiation, consistency, and coherence can be automatically analyzed.

45. The system of claim 44 wherein the user is given feedback if the answers are not reasonable enough, at least one of: during the filling process, after he/she has finished it, and at least after various stages have been completed.

46. The system claim 7 wherein for determining if the user is still Online without having to send short message every certain interval, at least one of the following methods is used:
a. The client software creates a hook or interface with the communication software and/or with the routines that are activated when the OS (Operating System) is shut down so that when the user closes the client software and/or the Internet connection and/or shuts down properly the OS, the client software can still first send to the IM server a message that the user has logout out, before letting the connection to actually be closed.
b. The IM server is automatically informed by other IM clients if they try to reach a client that is considered Online but don't succeed and thus the IM server can assume that that IM client is no longer Online.
c. If the IM server does not succeed in communicating with a client, the server can assume that the client is no longer Online.
d. If the server and/or other clients receive communications from a client that was considered to be offline, the receiving clients report it to the server and the server updates its status to Online.

47. The system of claim 7 wherein when dealing with people not currently Online the system automatically tries to come up with a list of most compatible dates who are most recent, and if the scores are not high enough and/or the list is not long enough, the system automatically decides to create instead a list containing also people who are less recent and so on in one or more steps, until the list is long enough and/or the scores are high enough and/or the recency compromise has reached backwards enough.

48. The system of claim 7 wherein if the user did not answer some questions, the system handles the missing values by at least one of:
a. Taking into account the average or most frequent answers in each question that the user did not answer.
b. Taking into account also the correlations of each missing answer with other answers
c. Giving a lower score for matching on missing values, in a way that reflects the uncertainty.

49. The system of claim 17 wherein when there is no direct match between the marked self image of the date and the user's marked preferences in these images, or vice versa, the system takes into account also the distance or similarity between the preferred images and the actual image, and at least one of the following features exists:
a. Said distance or similarity analysis is based on systematic classification of the images according to various variables.
b. Said actual image is the image or images that were marked by the other person as most similar to himself/herself.
c. The relevant parameters of each image are coded in advance as numeric data so that no actual image analysis is done during the compatibility search.
d. If the date submitted also an actual photo then the analysis of distance or similarity can be done in addition or instead also on the actual photo.

50. The system of claim 7 wherein if the user browses through photos of actual opposite sex users, he/she can request to view photos that are similar to one or more photos that he likes and then the system automatically shows him those photos, and/or this is used as one of the criteria for the automatic matching.

51. The system of claim 50 wherein the photos of actual users are automatically analyzed in advance after the user submits it according to various parameters in order to convert it into numerical codes, so that during the actual compatibility search and/or during searching for similar photos only these numerical codes are used.

52. The system of claim 17 wherein at least one of the following features exists:
a. The user can request to browse photos of actual users that are similar to any of the systematic photos that the user marked as desirable.
b. If a user submits an actual photo this photo can be automatically analyzed in order to correct the estimate that the user gave about how similar he is to photos of the systematic pool of images

53. The system of claim 7 wherein the mark that indicates if someone is currently online and/or the availability status of each date is automatically updated also on the list of compatible dates at least if the user saves the list or keeps the window of the list open, like in the automatic updating of the contactee list.

54. The system of claim 7 wherein dynamic web pages are used and for updating the online status of dates on the results list and/or for faster instant messaging through the browser at least one of the following features is used:
a. The refresh command is initiated automatically by the site when there is any change in the page, so that the browser can get a refresh even if it didn't ask for it.
b. The browser asks for refresh more often, but if nothing has changed then the browser gets just a code that tells it to keep the current page or window as is.
c. When the refresh is sent, it is a smart refresh, which tells the browser only what to change on the page instead of having to send the entire page again.

55. The system of claim 15 wherein instead of sending the notification as soon as possible after the new date becomes available, the system waits until one or more such highly compatible dates become available and if they do then the message is sent immediately, otherwise the system waits a certain time limit, and if no additional highly compatible dates that meet the criteria become available, then the message is sent anyway.
